(19) United States
(12) Patent Application Publication
(10) Pub. No.: US 2026/0168787 A1
(43) Pub. Date: Jun. 18, 2026

(54) Systems and Methods for Estimating Depth from Projected Texture using Camera Arrays

(71) Applicant: Adeia Imaging LLC, San Jose, CA (US)

(72) Inventors: Kartik Venkataraman, San Jose, CA (US); Jacques Duparré, Jena (DE)

(73) Assignee: Adeia Imaging LLC, San Jose, CA (US)

(21) Appl. No.: 19/468,938

(22) Filed: Feb. 3, 2026

Related U.S. Application Data
(63) Continuation of application No. 18/051,255, filed on Oct. 31, 2022, now Pat. No. 12,590,799.
Application No. 18/051,255 is a continuation of application No. 17/013,783, filed on Sep. 7, 2020, now Pat. No. 11,486,698.
Application No. 17/013,783 is a continuation of application No. 16/177,191, filed on Oct. 31, 2018, now Pat. No. 10,767,981.
Application No. 16/177,191 is a continuation of application No. 14/547,048, filed on Nov. 18, 2014, now Pat. No. 10,119,808.
(60) Provisional application No. 61/905,423, filed on Nov. 18, 2013.

(51) Int. Cl. G01B 11/22; G01B 11/25; G06T 7/40; G06T 7/521; G06T 7/557; G06T 7/593

(52) U.S. Cl. CPC G01B 11/22; G01B 11/2545; G06T 7/40; G06T 7/521; G06T 7/557; G06T 7/596; G06T 2207/10024

(57) ABSTRACT

Systems and methods for estimating depth from projected texture using camera arrays are described. A camera array includes a conventional camera and at least one two-dimensional array of cameras, where the conventional camera has a higher resolution than the cameras in the at least one two-dimensional array of cameras, an illumination system configured to illuminate a scene with a projected texture, where an image processing pipeline application directs the processor to: utilize the illumination system controller application to control the illumination system to illuminate a scene with a projected texture, capture a set of images of the scene illuminated with the projected texture, and determining depth estimates for pixel locations in an image from a reference viewpoint using at least a subset of the set of images.

### CROSS-REFERENCE TO RELATED APPLICATIONS

The current application is a continuation of U.S. patent application Ser. No. 18/051,255, entitled “Systems and Methods for Estimating Depth from Projected Texture using Camera Arrays” filed Oct. 31, 2022, and published as US 2023-0152087 on May 18, 2023, which is a continuation of U.S. patent application Ser. No. 17/013,783, entitled “Systems and Methods for Estimating Depth from Projected Texture using Camera Arrays” filed Sep. 7, 2020, and issued as U.S. Pat. No. 11,486,698 on Nov. 1, 2022, which is a continuation of U.S. patent application Ser. No. 16/177,191, entitled “Systems and Methods for Estimating Depth from Projected Texture using Camera Arrays” filed Oct. 31, 2018, and issued as U.S. Pat. No. 10,767,981 on Sep. 8, 2020, which is a continuation of U.S. patent application Ser. No. 14/547,048, entitled “Systems and Methods for Estimating Depth from Projected Texture using Camera Arrays” filed Nov. 18, 2014, and issued as U.S. Pat. No. 10,119,808 on Nov. 6, 2018, which claims priority under 35 U.S.C. § 119(e) to U.S. Provisional Ser. No. 61/905,423 , entitled “Structured Lighting System for Depth Acquisition in Texture-less Regions using Camera Arrays” filed Nov. 18, 2013, the disclosures of which are incorporated herein by reference.

### FIELD OF THE INVENTION

The present application relates generally to the use of multi-baseline stereo systems to perform depth estimation and more specifically to the use of projected texture multi-baseline stereo systems for performing depth estimation.

### BACKGROUND OF THE INVENTION

Camera arrays are typically passive depth acquisition devices that rely on texture in the scene to estimate depth. In image processing, the term texture or image texture is used to describe spatial arrangement of color or intensities in a region of an image. A region is considered to have texture when there is significant variation in color and/or intensity within the region. A region is said to be textureless when color and/or intensity are uniform or vary gradually. Disparity estimation processes used in multi-baseline stereo systems and camera arrays find correspondences between features visible in a set of images captured by the cameras in the system to determine depth. While this works for scenes with texture, depth estimation can fail in regions of a scene that lack texture due to insufficient features in the scene from which to determine pixel correspondences. Other depth cues can be used to compensate for an inability to recover depth based upon disparity including (but not limited to) shape from shading, depth from defocus, or other photogrammetry cues to determine depth in such flat (i.e. textureless) regions.

In a research report published in May of 1984 by the Artificial Intelligence Laboratory of the Massachusetts Institute of Technology entitled “PRISM: A Practical Real-Time Imaging Stereo Matcher” by Nishihara (A.I. Memo 780), a process for determining depth using binocular stereo in which a scene is illuminated with an unstructured texture pattern by a projector is disclosed. The illumination is intended to provide suitable matching targets on surfaces in which surface contrast is low compared with sensor noise and other inter-image distortions. The disclosed process illuminates the scene with a random pattern and the depth estimation process assumes no a priori knowledge of the illumination pattern.

Following the publication of the research report by the Artificial Intelligence Laboratory of the Massachusetts Institute of Technology, a number of research groups have observed that use of random projected patterns with binocular stereo cameras can lead to regions of depth ambiguity due to the projected pattern being too self-similar in specific regions of the projected pattern. Accordingly, alternative projection patterns have been proposed to avoid self-similar regions. J. Lim, “Optimized projection pattern supplementing stereo systems,” in ICRA, 2009 proposes utilizing patterns generated using De Bruijn sequences and K. Klonige, “Projected Texture Stereo,” in ICRA, 2010 proposes utilizing patterns generated based upon Hamming codes.

### SUMMARY OF THE INVENTION

Systems and methods in accordance with embodiments of the invention estimate depth from projected texture using camera arrays. One embodiment of the invention includes: at least one two-dimensional array of cameras comprising a plurality of cameras; an illumination system configured to illuminate a scene with a projected texture; a processor; and memory containing an image processing pipeline application and an illumination system controller application. In addition, the illumination system controller application directs the processor to control the illumination system to illuminate a scene with a projected texture. Furthermore, the image processing pipeline application directs the processor to: utilize the illumination system controller application to control the illumination system to illuminate a scene with a projected texture capture a set of images of the scene illuminated with the projected texture; determining depth estimates for pixel locations in an image from a reference viewpoint using at least a subset of the set of images. Also, generating a depth estimate for a given pixel location in the image from the reference viewpoint includes: identifying pixels in the at least a subset of the set of images that correspond to the given pixel location in the image from the reference viewpoint based upon expected disparity at a plurality of depths along a plurality of epipolar lines aligned at different angles; comparing the similarity of the corresponding pixels identified at each of the plurality of depths; and selecting the depth from the plurality of depths at which the identified corresponding pixels have the highest degree of similarity as a depth estimate for the given pixel location in the image from the reference viewpoint.

In a further embodiment, the at least one two-dimensional array of cameras comprises at least two two-dimensional arrays of cameras located in complementary occlusion zones surrounding the illumination system.

In another embodiment, a portion of a scene that is occluded in the field of view of at least one camera in a first of the two-dimensional arrays of cameras is visible in a plurality of cameras in a second of the arrays of cameras, where the first and second arrays of cameras are located in complementary occlusion zones on opposite sides of the illumination system.

In still further embodiment, the at least two two-dimensional arrays of cameras comprises a pair of two-dimensional arrays of cameras located in complementary occlusion zones on either side of the illumination system.

In still another embodiment, each array of cameras is a 2×2 array of monochrome cameras.

In a yet further embodiment, the projected texture includes a first spatial pattern period in a first direction and a second larger spatial pattern period in a second direction.

In yet another embodiment, the at least one two-dimensional array of cameras comprises one two-dimensional array of cameras including a plurality of lower resolution cameras and at least one higher resolution camera.

In a further embodiment again, the two-dimensional array of cameras comprises at least one lower resolution camera located above, below, to the left, and to the right of the higher resolution camera.

In another embodiment again, the higher resolution camera includes a Bayer filter pattern and the lower resolution cameras are monochrome cameras.

In a further additional embodiment, the image processing pipeline application configures the higher resolution camera to capture texture information when the illumination system is not illuminating the scene using the projected pattern.

In another additional embodiment, the projected texture includes a first spatial pattern period in a first direction and a second larger spatial pattern period in a second direction.

In a still yet further embodiment, the illumination system is a static illumination system configured to project a fixed pattern

In still yet another embodiment, the illumination system is a dynamic illumination system configured to project a controllable pattern; and the illumination system controller application directs the processor to control the pattern projected by the illumination system.

In a still further embodiment again, the illumination system includes a spatial light modulator selected from the group consisting of a reflective liquid crystal on silicon microdisplay and a translucent liquid crystal microdisplay.

In still another embodiment again, the image processing pipeline application directs the processor to: utilize the illumination system controller application to control the illumination system to illuminate a scene with a first projected texture; capture a first set of images of the scene illuminated with the first projected texture; determine initial depth estimates for pixel locations in an image from a reference viewpoint using at least a subset of the first set of images; utilize the illumination system controller application to control the illumination system to illuminate a scene with a second projected texture selected based upon at least one initial depth estimate for a pixel location in an image from a reference viewpoint; capture a second set of images of the scene illuminated with the second projected texture; and determine updated depth estimates for pixel locations in an image from a reference viewpoint using at least a subset of the first set of images.

In a still further additional embodiment, the spatial pattern period of the second projected texture at the at least one initial depth estimate for a pixel location in an image from a reference viewpoint is higher than the spatial resolution of the plurality of cameras at the at least one initial depth estimate for a pixel location in an image from the reference viewpoint.

In still another additional embodiment, the illumination system comprises an array of projectors.

In a yet further embodiment again, the array of projectors comprises projectors configured to project different patterns.

In yet another embodiment again, the different patterns comprise patterns having different spatial pattern periods.

In a further additional embodiment again, the projectors are configured to project controllable patterns; and the illumination system controller application directs the processor to control the patterns projected by the illumination system.

In another additional embodiment again, the projected pattern is random.

In another further embodiment, the projected pattern includes a smaller spatial pattern period in a first direction and a larger spatial pattern period in a second direction perpendicular to the first direction.

In still another further embodiment, the image processing pipeline application directs the processor to: utilize the illumination system controller application to control the illumination system to illuminate a scene with a projected texture; capture a first set of images of the scene illuminated with the projected texture; determining depth estimates for pixel locations in an image from a first reference viewpoint using at least a subset of the first set of images; utilize the illumination system controller application to control the illumination system to prevent the illumination of the scene with the projected texture; capture at least one image of the scene in which the natural texture of the scene is visible; and collocate natural texture and depth information for the scene.

In yet another further embodiment, the image processing pipeline application directs the processor to collocate natural texture and depth information for the scene by assuming that the first set of images and the at least one image are captured from the same viewpoint.

In another further embodiment again, at least one image of the scene in which the natural texture of the scene is visible is part of a second set of images of the scene in which the natural texture of the scene is visible. In addition, the image processing pipeline application further directs the processor to determining depth estimates for pixel locations in an image from a second reference viewpoint using at least a subset of the second set of images. Furthermore, the image processing pipeline application directs the processor to collocate natural texture and depth information for the scene by: identifying similar features in depth maps generated using the first and second sets of images; estimate relative pose using the similar features; and reprojecting depth estimates obtained using the first set of information into the second reference viewpoint.

In another further additional embodiment, the image processing pipeline application directs the processor to composite reprojected depth estimates generated using the first set of images and depth estimates generated using the second set of images based upon information concerning the reliability of the depth estimates.

Still yet another further embodiment includes: at least a pair of arrays of cameras located in complementary occlusion zones on either side of the illumination system, where each array of cameras comprises a plurality of cameras; an illumination system configured to illuminate a scene with a projected texture; a processor; and memory containing an image processing pipeline application and an illumination system controller application. In addition, the illumination system controller application directs the processor to control the illumination system to illuminate a scene with a projected texture. Furthermore, the image processing pipeline application directs the processor to: utilize the illumination system controller application to control the illumination system to illuminate a scene with a projected texture; capture a set of images of the scene illuminated with the projected texture; determining depth estimates for pixel locations in an image from a reference viewpoint using at least a subset of the set of images. Also, generating a depth estimate for a given pixel location in the image from the reference viewpoint includes: identifying pixels in the at least a subset of the set of images that correspond to the given pixel location in the image from the reference viewpoint based upon expected disparity at a plurality of depths along a plurality of epipolar lines aligned at different angles; comparing the similarity of the corresponding pixels identified at each of the plurality of depths; and selecting the depth from the plurality of depths at which the identified corresponding pixels have the highest degree of similarity as a depth estimate for the given pixel location in the image from the reference viewpoint.

### BRIEF DESCRIPTION OF THE DRAWINGS

FIG. 1A conceptually illustrates a camera array including a pair of arrays of cameras that each include an M x N arrays in accordance with an embodiment of the invention.

FIG. 1B conceptually illustrates a camera array including two arrays of cameras located on either side of an illumination system, where the arrays of cameras each include two monochrome cameras 104 in accordance with an embodiment of the invention.

FIG. 1C conceptually illustrates a camera array that utilizes two 2×2 arrays of monochrome cameras located in complementary occlusion zones on either size of an illumination system in accordance with an embodiment of the invention.

FIG. 1D conceptually illustrates a camera array including two 3×3 arrays of cameras located in complementary occlusion zones on either side of an illumination system, where each of the 3×3 arrays 102 of cameras forms a π filter group, in accordance with an embodiment of the invention.

FIG. 1E conceptually illustrates a camera array including two 1×4 linear arrays of cameras located in complementary occlusion zones on either side of an illumination system, where each of the 1×4 linear arrays 102 of cameras 104 includes two Green cameras, one Red camera, and one Blue camera, in accordance with an embodiment of the invention.

FIG. 1F conceptually illustrates a camera array including four arrays of cameras located in two pairs of complementary occlusion zones surrounding an illumination system in accordance with an embodiment of the invention.

FIG. 1G conceptually illustrates a camera array including a single array of cameras and a single illumination system in accordance with an embodiment of the invention.

FIG. 1H conceptually illustrates a camera array including two illumination systems located in complementary occlusion zones on either side of an array of cameras in accordance with an embodiment of the invention.

FIG. 1I conceptually illustrates a camera array including a conventional camera, an array of cameras, and an illumination system in accordance with an embodiment of the invention.

FIG. 2A conceptually illustrates epipolar lines utilized to perform disparity searches in a 2×2 array of monochrome cameras.

FIG. 2B conceptually illustrates epipolar lines utilized to perform disparity searches in a 5×5 array of monochrome cameras incorporating Green, Red and Blue cameras.

FIG. 3A conceptually illustrates a diffractive static illumination system in accordance with an embodiment of the invention.

FIG. 3B conceptually illustrates a static illumination system in which light from the light source is directly incident on the DOE.

FIG. 3C conceptually illustrates an illumination system including a reflective spatial light modulator system.

FIG. 3D conceptually illustrates an illumination system including a translucent spatial light modulator system.

FIG. 3E conceptually illustrates the comparative field of view onto which an illumination system projects light and the fields of view of cameras in a camera array.

FIG. 4A conceptually illustrates an array of projectors that project collimated light through DOEs in accordance with an embodiment of the invention.

FIG. 4B conceptually illustrates an array of projectors that project collimated light through DOEs through a lens that focuses the light on a focal plane in accordance with an embodiment of the invention.

FIG. 4C conceptually illustrates a projector array formed by a plurality of LEDS.

FIG. 4D conceptually illustrates an array of projectors that focuses light emerging from the projector microlenses on a focal plane using a lens in accordance with an embodiment of the invention.

FIGS. 4E-4I conceptually illustrate Gray code patterns that can be used to generate a non-random projected texture.

FIGS. 4J-4M conceptually illustrate the use of projected patterns incorporating randomly located dots having different sizes in accordance with some embodiments of the invention.

FIGS. 5A-5I illustrate camera array systems corresponding to the camera array systems illustrated in FIGS. 1A-1I with the exception that the illumination systems include an array of projectors.

FIG. 6 is a flow chart illustrating a process for collocating natural texture and depth information in accordance with an embodiment of the invention.

FIG. 7 is a flow chart illustrating a process for reprojecting depth information into the viewpoint of a set of texture information in accordance with an embodiment of the invention.

### DETAILED DISCLOSURE OF THE INVENTION

Turning now to the drawings, systems and methods for estimating depth from projected texture using camera arrays in accordance with embodiments of the invention are illustrated. In several embodiments, a camera array is used to perform three-dimensional scanning of an object illuminated by a projected texture. In other embodiments, the camera array is configured to capture a depth map of a scene illuminated by a projected texture.

In many embodiments, a two dimensional array of cameras is utilized to capture a set of images of a scene illuminated by a projected texture and depth is estimated by performing disparity searches using the set of images. Corresponding pixels in the set of images captured by the cameras in the two dimensional array of cameras are located on different epipolar lines. When a random projection pattern is used, depth estimates can be unreliable where regions along an epipolar line are self-similar. With each increase in the number of different epipolar lines searched, the likelihood that a random projected pattern will be self-similar at each of the corresponding locations along the epipolar lines decreases.

In several embodiments, multiple cameras in the camera array are located in complementary occlusion zones around an illumination system so that depth estimates can be obtained when a projected pattern is occluded from the field of view of cameras located on one side of the illumination system by a foreground object. By distributing multiple cameras on either side of the illumination system, multiple cameras see the projected pattern in a region occluded from the fields of view of other cameras in the array. Therefore, depth estimates can be made using the subset of the images captured by the camera array in which the projected pattern is visible (i.e. unoccluded). In certain embodiments, the baseline between the camera arrays is larger than the baseline between cameras within a camera array. Accordingly, disparity observed along a first epipolar line will be significantly greater than disparity observed along a second (perpendicular) epipolar line. Therefore, a projected pattern can be utilized that incorporates a smaller spatial pattern period in a direction corresponding to the second epipolar line. For example, a pattern with a larger horizontal spatial pattern period than the vertical spatial pattern period can be utilized with a camera array in which a wide horizontal baseline exists between a pair of two-dimensional arrays of cameras and the largest vertical baseline between cameras in a two-dimentional array of cameras is significantly smaller than the horizontal baseline. In other embodiments, differences in spatial pattern periods can be employed along different axes within a projected pattern as appropriate to the requirements of a specific application.

In certain embodiments, a camera array including a set of lower resolution cameras and at least one higher resolution camera is utilized in combination with an illumination system. As is discussed in detail in U.S. Patent 2011/0069189 entitled “Capturing and Processing of Images Using Monolithic Camera Array with Heterogeneous Imagers” to Venkataraman et al. camera arrays can include cameras having different lenses and different resolutions. An array of lower resolution cameras can be utilized to estimate depth (irrespective of whether cameras in the array are located in complementary occlusion zones around the projector) and the higher resolution camera(s) utilized to acquire color information. In several embodiments, the lower resolution cameras are located in complementary occlusion zones around the higher resolution camera. In a number of embodiments at least one lower resolution camera is located above, below, to the left and to the right of the higher resolution camera.

A variety of illumination systems can be utilized to project texture. In several embodiments, static illumination systems are utilized that project a fixed pattern. In a number of embodiments, dynamic illumination systems are utilized in which the projected pattern is controllable. As discussed further below, camera arrays in accordance with many embodiments of the invention can control the projected pattern so that the spatial pattern period of the projected texture is selected to provide the greatest depth estimation precision at the depths at which objects are observed in the scene. In certain embodiments, an illumination system incorporating an array of projectors is utilized. In several embodiments, the projector array projects a fixed pattern. In other embodiments, the pattern projected by the projector array is controllable so that the spatial resolution of the intensity contrast is selected to provide the greatest depth estimation precision at the depths at which objects are observed in the scene. In a number of embodiments, the focal length of a projector in the illumination system is adjustable to coordinate spatial pattern period with the distance to an object within the scene.

Camera arrays that estimate depth using projected texture in accordance with embodiments of the invention are discussed further below.

### Camera Arrays Incorporating Projectors

Passive depth acquisition systems, such as the camera arrays described in U.S. Pat. No. 8,619,082 entitled “Systems and Methods for Parallax Detection and Correction in Images Captured Using Array Cameras that Contain Occlusions using Subsets of Images to Perform Depth Estimation” to Ciurea et al., have a depth accuracy that is fundamentally dependent on three aspects of the camera array: (i) camera array geometry including (but not limited to) the baseline separation between the cameras in the array; (ii) focal length of the camera lenses; and (iii) pixel size of the sensors in each of the cameras. The relevant portions of U.S. Pat. No. 8,619,082 concerning depth estimation using sets of images is hereby incorporated by reference herein in its entirety. Generally, the accuracy of depth estimates made by performing disparity searches with respect to images captured by a camera array falls away inversely with distance of an object from the camera array. Illumination systems utilized in combination with camera arrays in accordance with many embodiments of the invention project texture so that, at any given distance from the camera array, the spatial density of contrasting intensities within the projected texture is no higher than the error in the depth generated by the disparity estimation algorithm at that distance. Stated another way, transitions between contrasting intensities in the projected texture are observable over two or more pixels. Where transitions between contrasting intensities in a projected texture have a spatial density that is higher than the spatial resolution of the cameras in the camera array, the images captured by the cameras in the array will average the projected texture with the result that the projected texture is less useful for performing depth estimation. In a number of embodiments, the illumination system is controllable so that the spatial density of projected texture is programmable. In this way, the projected texture can be dynamically configured based upon the distance of objects being illuminated.

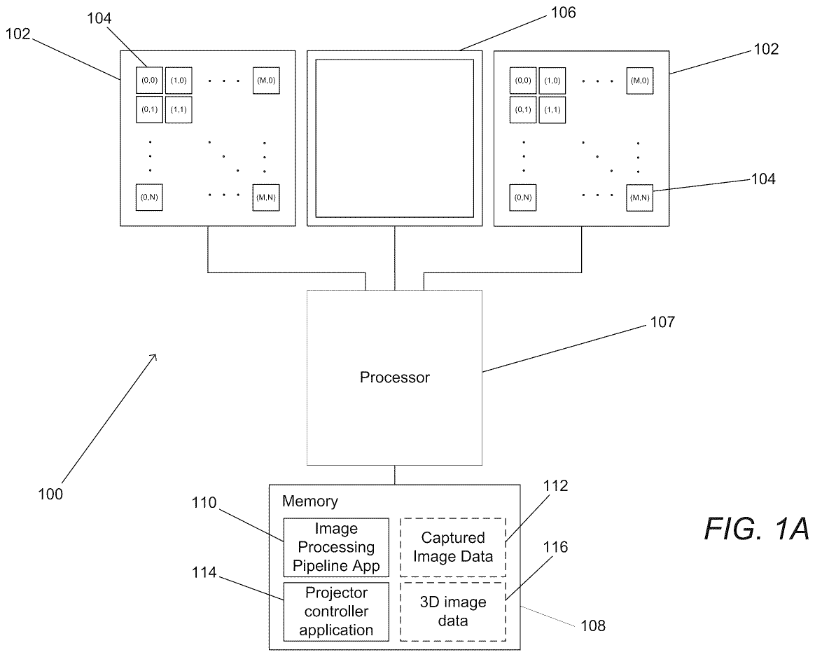

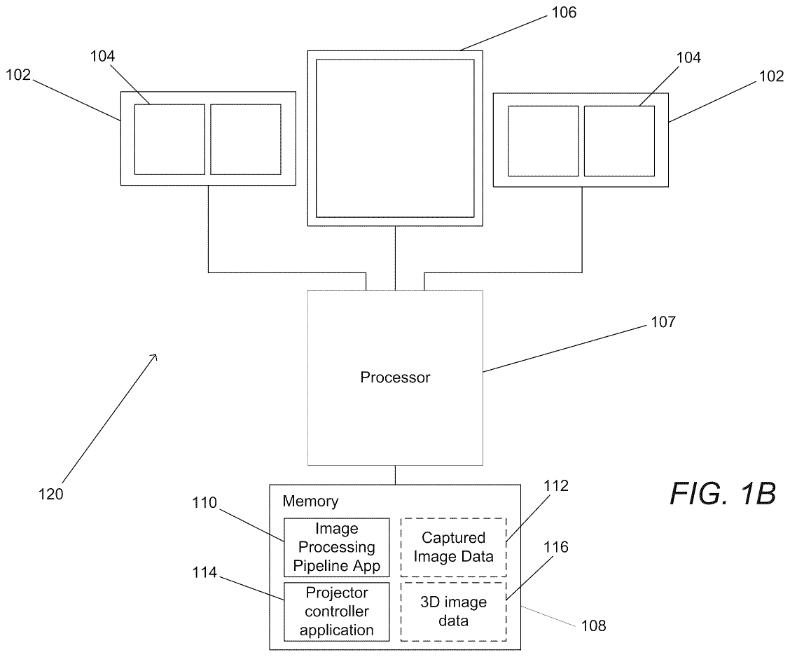

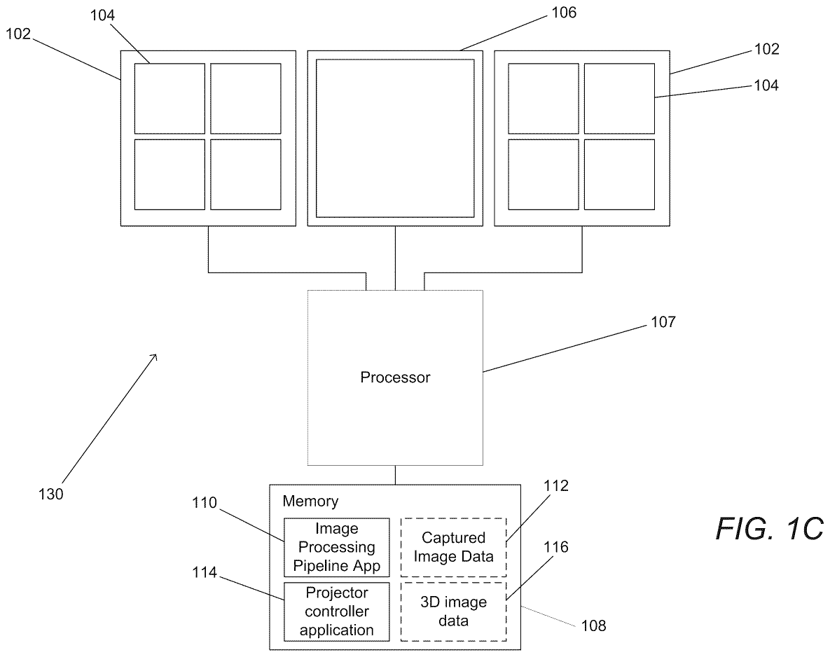

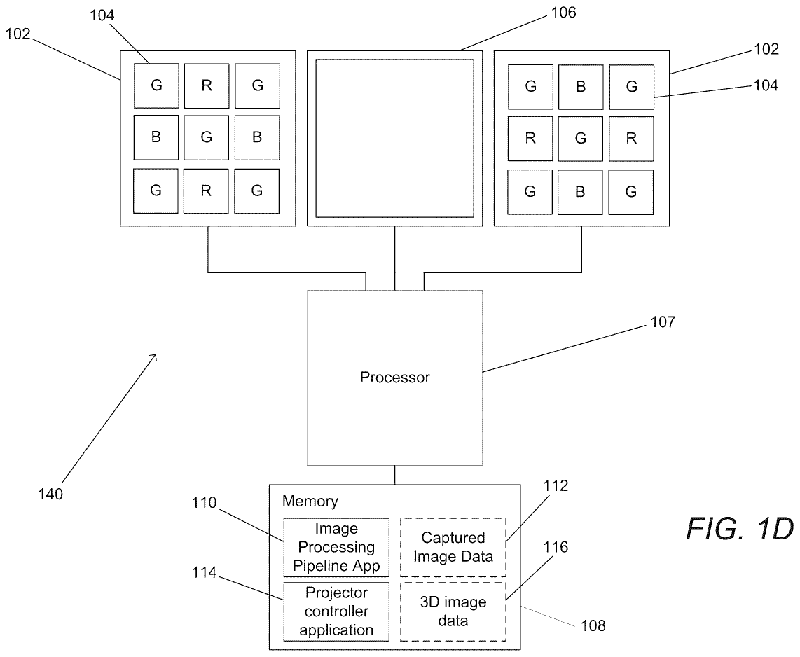

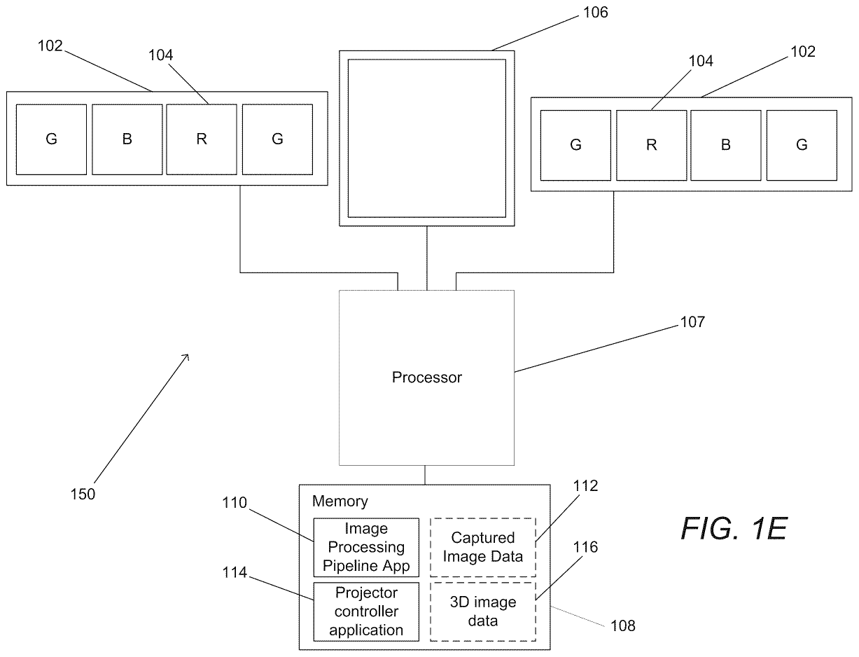

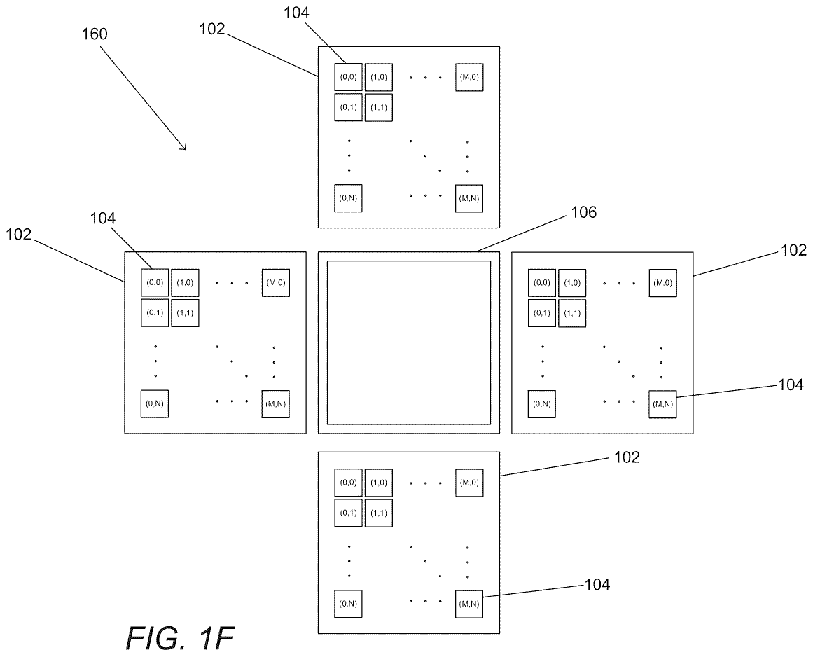

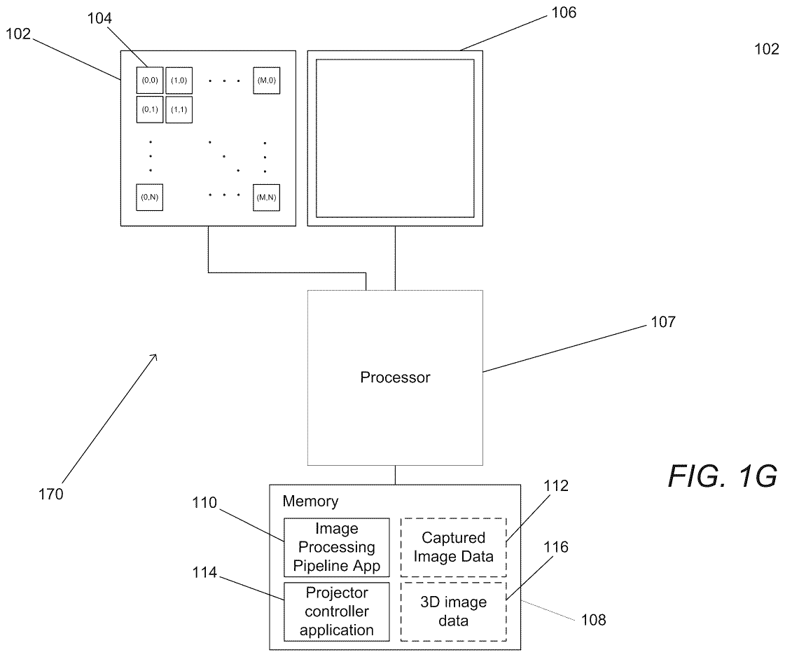

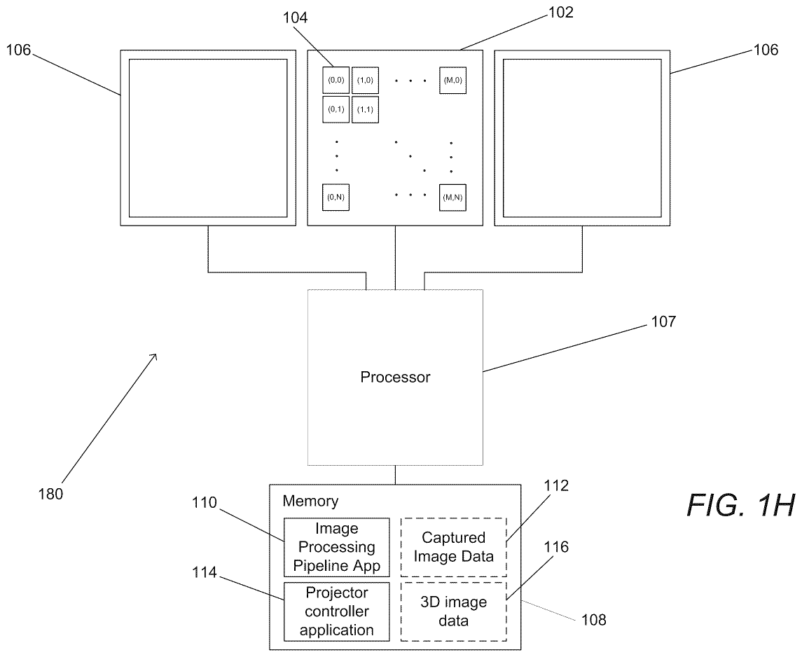

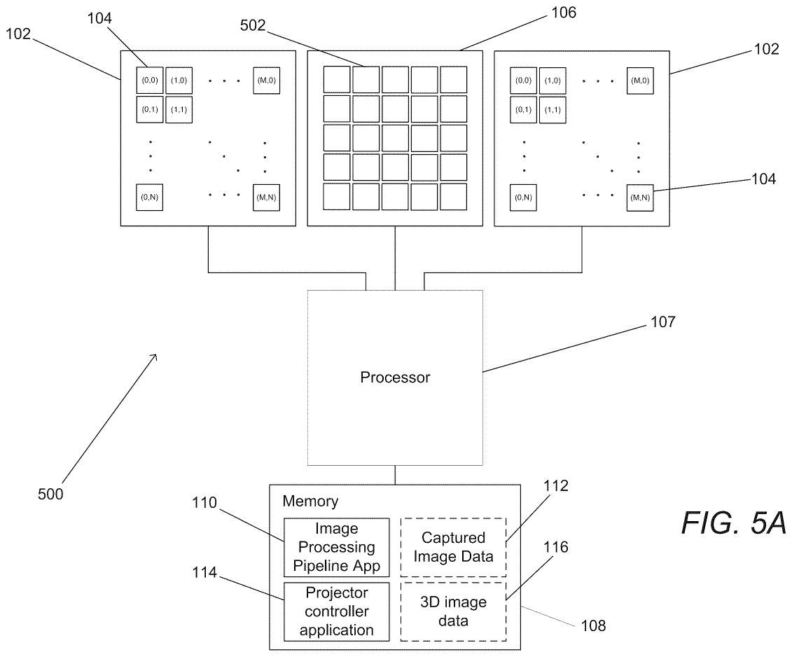

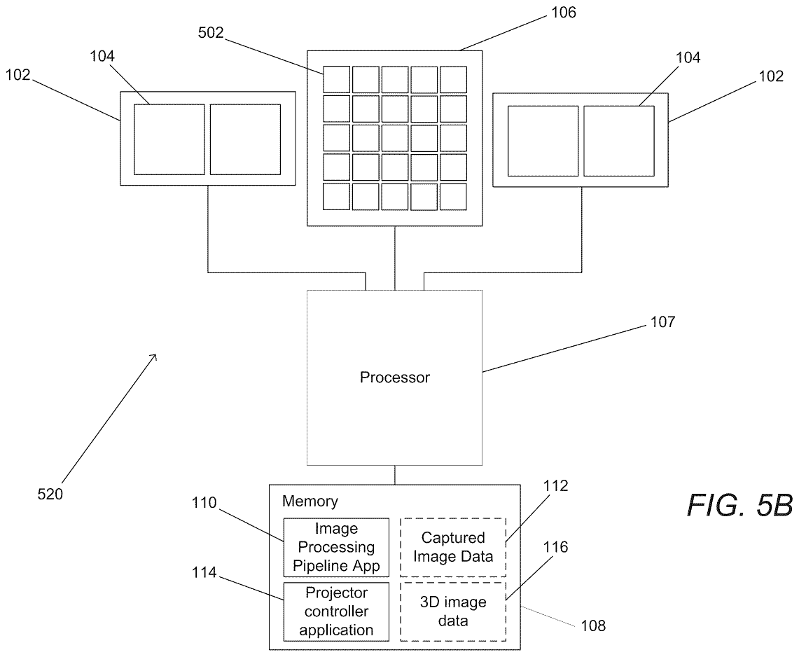

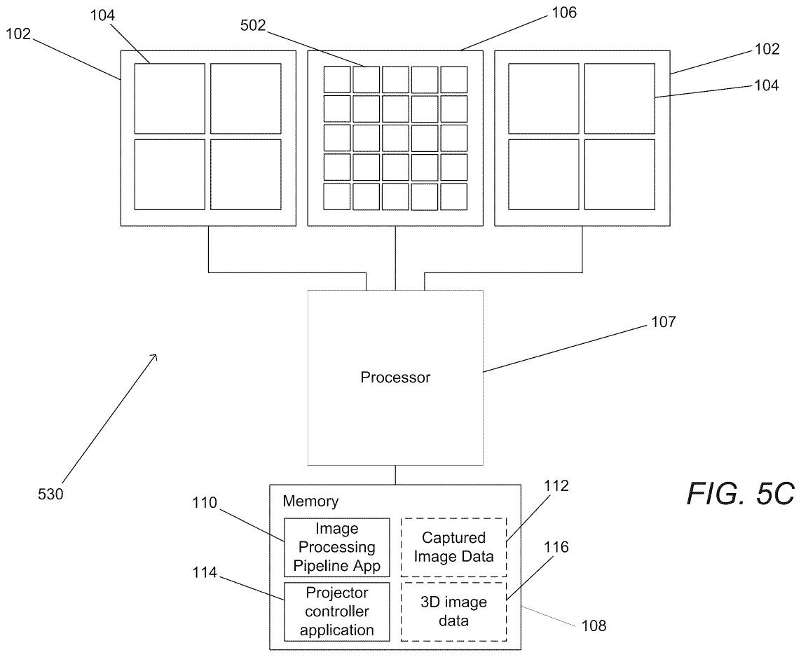

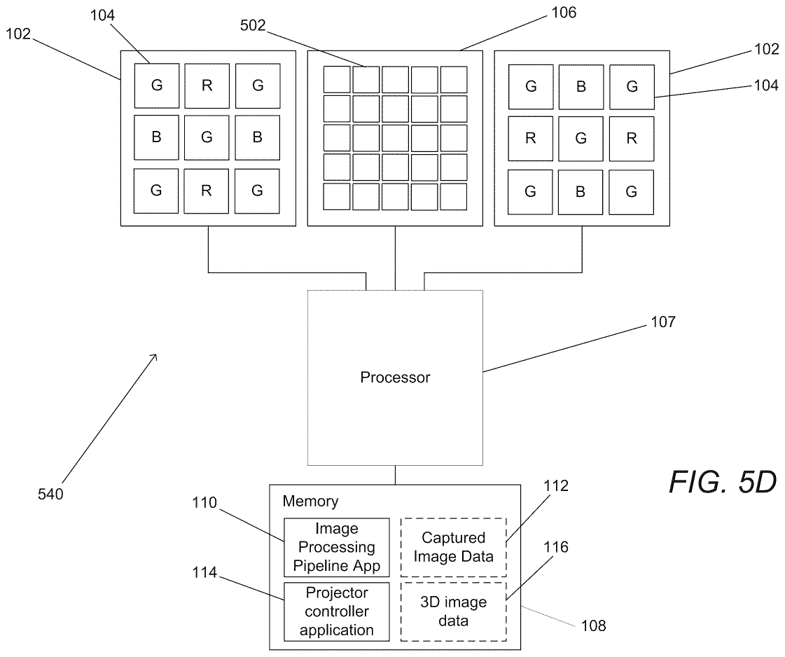

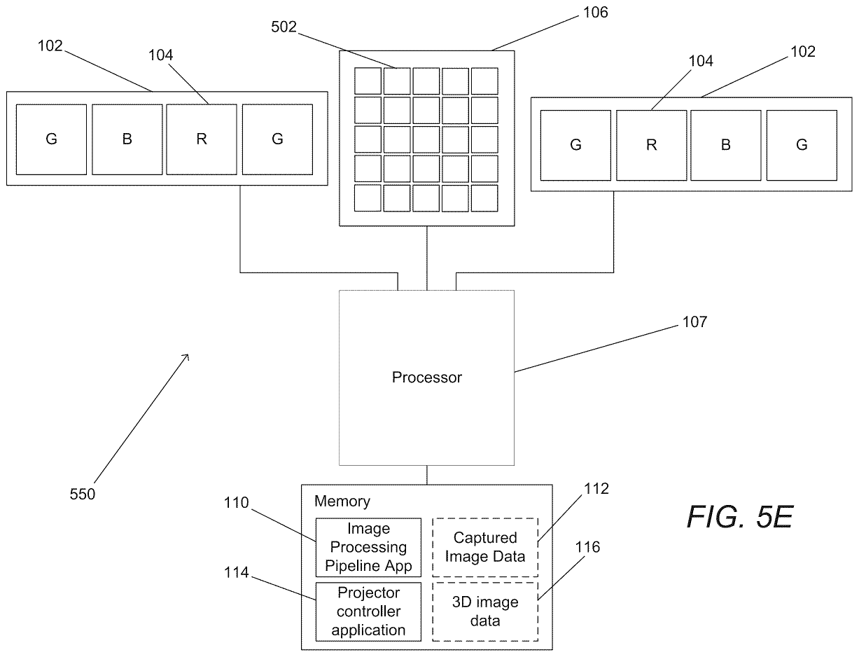

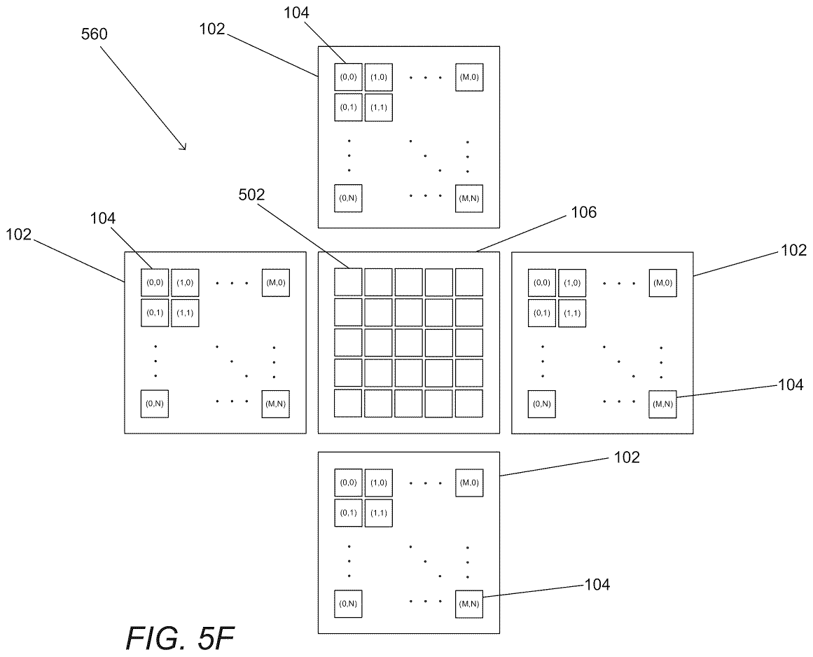

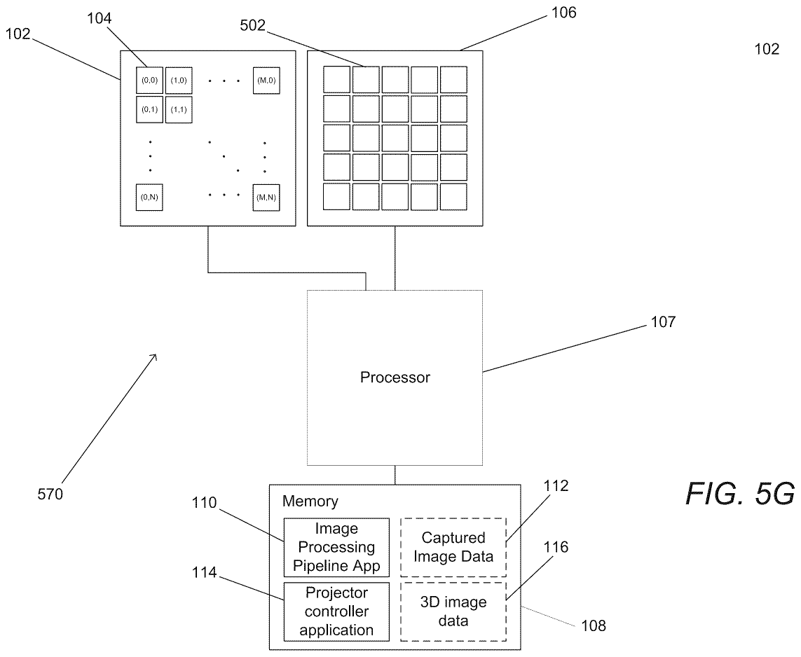

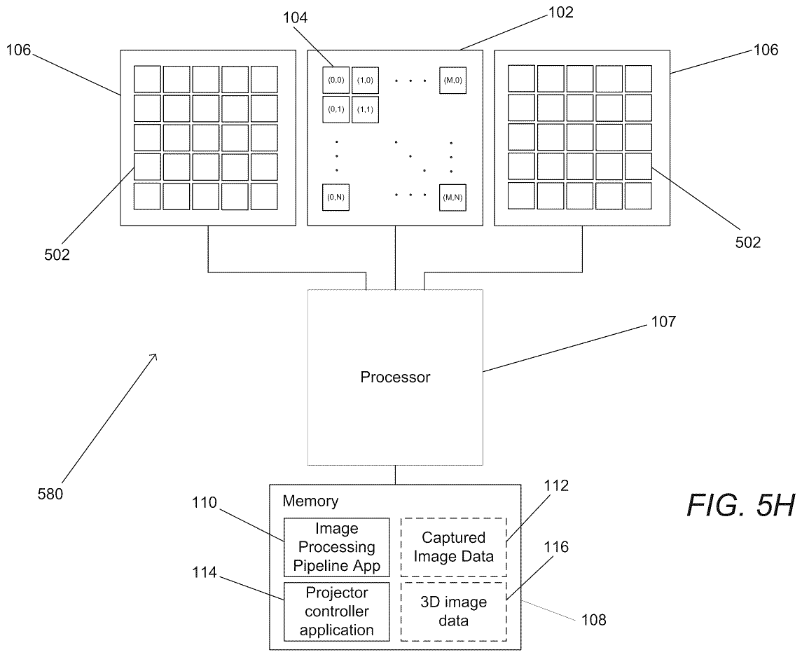

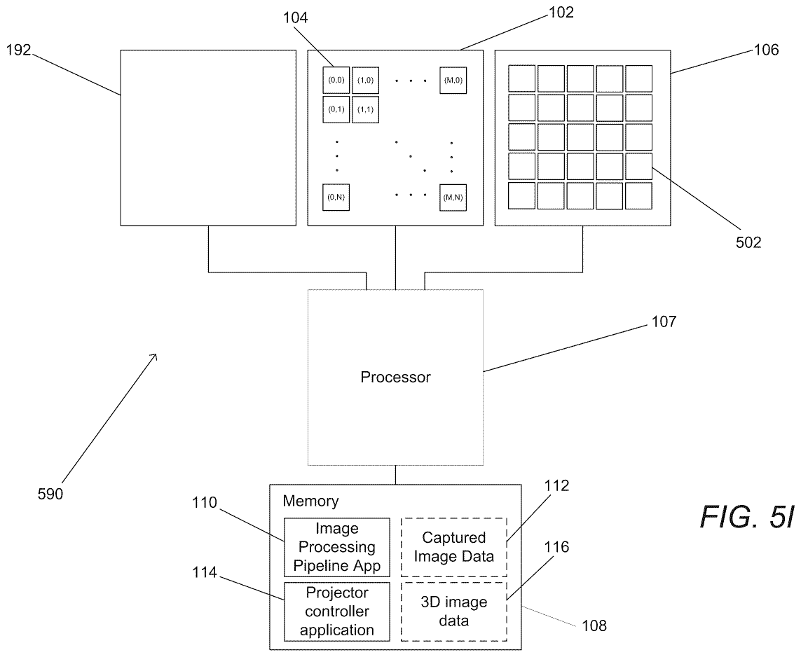

A variety of camera arrays incorporating illumination systems in accordance with embodiments of the invention are illustrated in FIGS. 1A-1I and 5A-5I. The camera array 100 illustrated in FIG. 1A includes a pair of arrays 102 of cameras 104 that each include an M×N arrays of cameras 104. The camera arrays 102 are located in complementary occlusion zones on either size of an illumination system 106. The camera arrays 102 and the illumination system 106 are controlled and communicate with a processor 107. The processor is also configured to communicate with one or more different types of memory 108 that can be utilized to store an image processing pipeline application 110, image data 112 captured by the camera arrays 102, a projector controller application 114 and 3D image data 116. As is discussed further below, the 3D image data can include (but is not limited to) depth maps, meshes, color information, texture information, and/or point clouds. In many embodiments, the camera array is used as a 3D scanner to build a point cloud. In other embodiments, the camera array is used to capture images and/or video of a scene and corresponding depth maps.

A problem that can be encountered using an illumination system to project texture onto a scene for the purpose of performing depth estimation is that portions of the scene can be occluded in the field of view of one or more cameras in the camera array. Furthermore, foreground objects can occlude portions of the scene so that portions of the scene that are not illuminated by projected texture are visible within the field of view of one or more cameras in the camera array. In several embodiments, multiple cameras are located in complementary occlusion zones on either side of the projector. In this way, a portion of the scene that is not visible within the field of view of one or more cameras on a first side of the projector is visible within the field of view of multiple cameras on the opposite side of the projector.

When monochrome cameras are utilized to estimate depth, as few as two cameras can be located in complementary occlusion zones on either side of the projector. A camera array 120 including two arrays of cameras 102 located on either side of an illumination system 106, where the arrays of cameras each include two monochrome cameras 104 is illustrated in FIG. 1B. Suitable monochrome cameras include, but are not limited to, monochrome cameras that image the visible spectrum, monochrome cameras that image portions of the infrared (IR) spectrum, and/or monochrome cameras that image portions of the visible spectrum and portions of the IR spectrum.

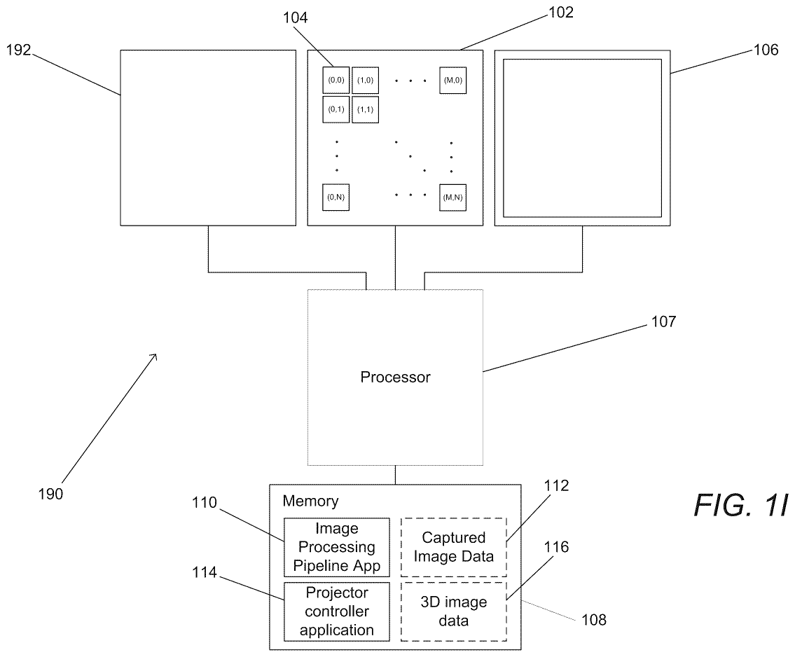

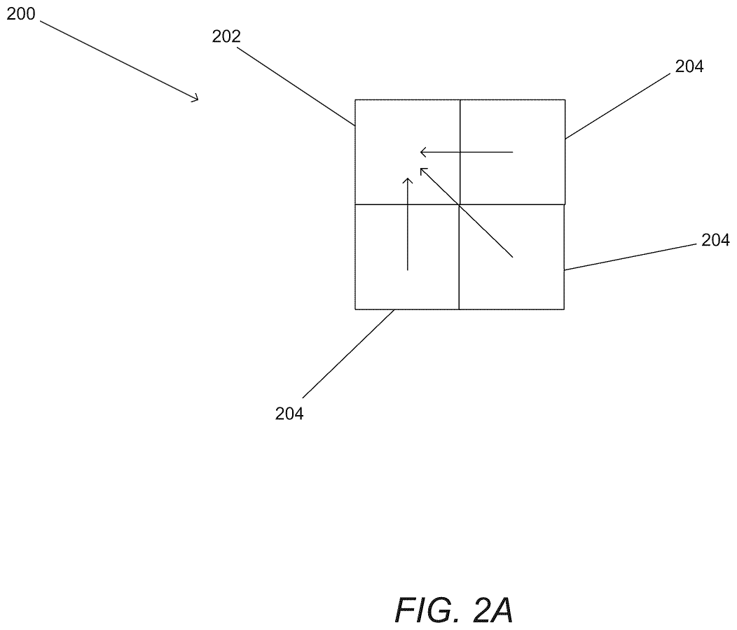

In many embodiments, two dimensional arrays of cameras are utilized in complementary occlusion zones surrounding the illumination system. Estimating depth using a set of images captured by a linear array of cameras typically involves performing disparity searches along epipolar lines aligned at the same angle. As is discussed further below with reference to FIGS. 2A and 2B, estimating depth using a set of images captured by a two dimensional array of cameras typically involves performing disparity searches along epipolar lines aligned at different angles. When the illumination system 106 generates a random pattern, the likelihood that self-similar patches will exist in corresponding locations along multiple epipolar lines aligned at different angles is less likely than the case involving performing disparity searches along epipolar lines aligned at the same angle. Accordingly, the use of two dimensional arrays of cameras located in complementary occlusion zones around an illumination system can significantly enhance depth estimation performance. A camera array 130 that utilizes two 2×2 arrays 102 of monochrome cameras 104 located in complementary occlusion zones on either size of an illumination system 106 in accordance with an embodiment of the invention is illustrated in FIG. 1C. As noted above with respect to FIG. 1A, camera arrays in accordance with many embodiments of the invention can include any number of cameras in linear arrays and two-dimensional arrays located in complementary occlusion zones on either side of an illumination system.

The camera arrays described above with reference to FIGS. 1B and 1C include monochrome cameras. In several embodiments, the camera arrays can include cameras that image in multiple spectral channels such as (but not limited to) cameras that employ Bayer filters. In many embodiments, the arrays of cameras located in complementary occlusion zones on either side of an illumination system include different types of cameras. For example, cameras that capture different color channels can be located in each of the groups of cameras. So long as multiple cameras that capture image data in one color channel are located in each the complementary occlusion zones, then depth estimation can be performed within regions of the image that are occluded by foreground objects.

A camera array 140 including two 3×3 arrays 102 of cameras 104 located in complementary occlusion zones on either side of an illumination system 106, where each of the 3×3 arrays 102 of cameras forms a π filter group is illustrated in FIG. 1D. Each 3×3 array of cameras includes a central Green camera, a pair of Blue cameras and Red cameras in complementary occlusion zones on either side of the central Green camera and four Green cameras. In the illustrated embodiment, the pairs of Red and Blue cameras are in alternate complementary occlusion zones in each of the two arrays of cameras. In other embodiments, the same configuration of cameras can be utilized in each π filter group. While specific π filter groups are descried above with reference to FIG. 1D, π filter groups that include a variety of different types of cameras including (but not limited to) central Bayer cameras, and central near-IR cameras are described in detail in U.S. Patent Publication No. 2013/0293760 entitled “Camera Modules Patterned with pi Filter Groups”, to Nisenzon et al., the relevant disclosure from which concerning arrangements of cameras including different spectral filters in camera arrays is hereby incorporated by reference herein in its entirety.

A camera array 150 including two 1×4 linear arrays 102 of cameras 104 located in complementary occlusion zones on either side of an illumination system 106, where each of the 1×4 linear arrays 102 of cameras 104 includes two Green cameras, one Red camera, and one Blue camera, in accordance with an embodiment of the invention is illustrated in FIG. 1E. As can readily be appreciated, the number of cameras included in each linear array depends upon the number of spectral channels imaged by the camera array 150 and can include multiple cameras in each spectral channel located in each of the complementary occlusion zones as appropriate to the requirements of specific applications.

While the camera arrays described above with respect to FIGS. 1A-1E involve placement of arrays of cameras in complementary occlusion zones on either side of an illumination system, camera arrays in accordance with many embodiments of the invention can include multiple cameras placed in multiple sets of complementary occlusion zones surrounding an illumination system. A camera array 160 including four arrays 102 of cameras 104 located in two pairs of complementary occlusion zones surrounding an illumination system 106 is illustrated in FIG. 1F. In other embodiments, the illumination system can be completely surrounded or ringed by cameras. In several embodiments, cameras are placed in a single ring surrounding the illumination system so that the cameras form pairs of cameras in complementary occlusion zones on opposite sides of the ring. In many embodiments, the ring includes at least eight cameras. In certain embodiments, the ring includes at least 12 cameras. As can readily be appreciated, the number of cameras and the placement of the cameras in complementary occlusion zones surrounding the illumination system is largely dependent upon the requirements of a specific application.

While the placement of multiple cameras in complementary occlusion zones surrounding an illumination system can be desirable in many applications, camera arrays incorporating illumination systems for projecting texture in accordance with a number of embodiments of the invention can include cameras that are not located in complementary occlusion zones. Significant performance improvements can be achieved by simply pairing a single two-dimensional camera array with an illumination system (particularly in 3D scanning applications where occlusions are less of a concern). A camera array 170 including a single array 102 of cameras 104 and a single illumination system 106 in accordance with an embodiment of the invention is illustrated in FIG. 1G. As noted above and discussed further below with reference to FIGS. 2A and 2B, estimating depth using a set of images captured by a two dimensional array of cameras typically involves performing disparity searches along epipolar lines aligned at different angles. When the illumination system 106 generates a random pattern, the likelihood that self-similar patches will exist in corresponding locations along multiple epipolar lines aligned at different angles is less likely than the case involving performing disparity searches along epipolar lines aligned at the same angle. Accordingly, the use of a two dimensional array of cameras can significantly enhance depth estimation performance relative to the depth estimation performance achieved using a binocular pair. While a binocular pair will fail when a portion of the scene is occluded in the field of view of one of the cameras, the same is not necessarily true with a two dimensional array of cameras (depending upon the size of the two dimensional array). To the extent that foreground objects prevent portions of the scene from being illuminated with the projected texture, the camera array can attempt to perform depth estimation using the texture inherent to the scene and/or accommodate high uncertainty depths where insufficient texture is available. The same approach can be utilized by camera arrays that incorporate multiple cameras in complementary occlusion zones. Alternatively, such camera arrays can attempt to estimate depth from a virtual viewpoint collocated with the illumination system. In this way, only portions of the scene on which texture is projected are within the field of view of the virtual viewpoint.

The issue of foreground objects preventing illumination of portions of the scene by projected texture can be addressed by utilizing multiple projectors. Locating illumination systems in complementary occlusion zones on either side of the camera array increases the likelihood that a portion of the scene visible from the viewpoint of a reference camera in the camera array is illuminated by projected texture. A camera array 180 including two illumination systems located in complementary occlusion zones on either side of an array 102 of cameras 104 in accordance with an embodiment of the invention is illustrated in FIG. 1H. As can readily be appreciated, any number of illumination systems can be located in different complementary occlusion zones surrounding the array of cameras as appropriate to the requirements of specific applications. As discussed further below, many illumination systems utilized in accordance with embodiments of the invention incorporate arrays of projectors. In several embodiments, the camera array is surrounded by an array of projectors. In a number of embodiments, the camera array is surrounded by a ring of projectors. The specific configuration of the projectors in the array of projectors is largely dependent upon the requirements of a specific application.

In many applications, an array of cameras is paired with a conventional camera. In several embodiments, the array of cameras is utilized to perform a first function such as (but not limited to) capturing still photos and/or performing depth estimation. The conventional camera can be utilized to perform a second function such as (but not limited to) capturing video sequences and/or high resolution images. In a particular set of embodiments, the conventional camera is utilized to capture images and video sequences and the array of cameras is utilized to capture image data that is utilized to determine depth. Depth maps generated using the array of cameras can be reprojected into the field of view of the conventional camera. In a number of embodiments, the camera array includes one or more illumination systems that project texture onto a scene. In several embodiments, image data is captured by the conventional camera and then the scene is illuminated by the projected texture and image data is captured by the array of cameras. As can readily be appreciated, the sequencing of the capture of image data can be reversed. In other embodiments, image data is also captured by the array of cameras when the scene is not illuminated by the illumination system. Various processes for registering depth maps generated using a scene illuminated with projected texture and image data captured when the scene is not illuminated with projected texture are discussed further below. A camera array 190 including a conventional camera 192, an array 102 of cameras 104, and an illumination system 106 in accordance with an embodiment of the invention is illustrated in FIG. 1I. The conventional camera 192 is typically higher resolution than the cameras 104 in the array 102. The conventional camera 192 may, however, have the same resolution and/or a lower resolution to that of one or more of the cameras 104 in the array 102. In several embodiments, the conventional camera is a Bayer camera and the cameras 104 in the array 102 of cameras can include (but are not limited to) monochrome cameras of the same type, monochrome cameras that image different portions of the spectrum, and Bayer cameras. In many embodiments, the conventional camera 192 is formed as a first camera module and the array of cameras is formed as a second camera module. In other embodiments, the layout of the conventional camera and the array of cameras enables the use of a single camera module incorporating all of the cameras. In the illustrated embodiment, the array 102 of cameras 104 is located between the conventional camera 192 and the illumination system 106. Ideally, the array 102 of cameras 104 is located as close to the conventional camera 192 as possible so that very little of the scene visible within the field of view of the conventional camera is occluded from the fields of view of the cameras in the array of cameras. By locating the illumination system 106 on the opposite side of the array 102 of cameras 104 from the conventional camera 192, foreground objects are likely to prevent illumination of portions of the scene that are occluded in fields of view of the cameras in the array of cameras. In certain embodiments, an alternative configuration is utilized in which the conventional camera is located between the array of cameras and the illumination system. In a number of embodiments, cameras from the array are located in complementary occlusion zones surrounding the conventional camera. In many embodiments, at least one camera is located above, below, to the left, and to the right of the conventional camera. In several embodiments, illumination systems are located in complementary occlusion zones surrounding the array of cameras. In many embodiments, cameras in the array of cameras are located in complementary occlusion zones on either side of the conventional camera and illumination systems are located in complementary occlusion zones on either side of the conventional camera. In other embodiments, a single illumination system is adjacent a conventional camera surrounded by an array of cameras. As can readily be appreciated, the locations of one or more conventional camera(s), the cameras in the array of cameras, and one or more illumination systems is largely dependent upon the requirements of a specific application.

The camera arrays 102 can be constructed from an array camera module or sensor including an array of focal planes and an optic array including a lens stack for each focal plane in the array camera module. Sensors including multiple focal planes and the operation of such sensors are discussed in U.S. Patent Publication No. 2012/0012748 entitled “Architectures for System on Chip Array Cameras”, to Pain et al., the relevant disclosure from which is incorporated herein by reference in its entirety. A sensor including a single array of pixels on which images are formed by the optics of each camera can also be utilized to capture image data. In several embodiments, each camera includes a separate sensor. In many embodiments, individual lens barrels are utilized to implement the optics of the camera. Array camera modules incorporating cameras implemented using combinations of separate sensors and optic arrays, separate sensors and separate lens barrels and a single sensor and separate lens barrels in accordance with embodiments of the invention are disclosed in U.S. patent application Ser. No. 14/536,537 entitled “Methods of Manufacturing Array Camera Modules Incorporating Independently Aligned Lens Stacks” to Rodda et al. filed Nov. 7, 2014, the relevant disclosure from which is incorporated by reference herein in its entirety. Light filters can be used within each optical channel formed by the optics of a camera in the array camera module to enable different cameras to capture image data with respect to different portions of the electromagnetic spectrum. As can readily be appreciated, the construction of an array of cameras utilized in combination with an illumination system is typically dependent upon the requirements of a specific application.

The illumination system 106 projects texture onto a scene that is utilized to estimate depths of objects within the scene. A variety of illumination systems can be utilized to project texture. In several embodiments, static illumination systems are utilized that project a fixed pattern. In a number of embodiments, dynamic illumination systems are utilized in which the projected pattern is controllable. As discussed further below, camera arrays in accordance with many embodiments of the invention can control the projected pattern so that the spatial pattern period of the projected texture is selected to provide the greatest depth estimation precision at the depths at which objects are observed in the scene. In certain embodiments, an illumination system incorporating an array of projectors is utilized. In several embodiments, the projector array projects a fixed pattern. In other embodiments, the pattern projected by the projector array is controllable so that the spatial resolution of the intensity contrast or spatial pattern period is selected to provide the greatest depth estimation precision at the depths at which objects are observed in the scene.

The processor 107 can include logic gates formed from transistors (or any other device) that are configured to dynamically perform actions based on the instructions stored in the memory. Accordingly, processors in accordance with many embodiments of the invention can be implemented using one or more microprocessor(s), coprocessor(s), application specific integrated circuit(s) and/or an appropriately configured field programmable gate array(s) that are directed using appropriate software to control various operating parameters of the camera arrays.

In a variety of embodiments, the memory 108 includes circuitry such as, but not limited to, memory cells constructed using transistors, that are configured to store instructions. The image processing pipeline application 110 and the projector controller application 114 are typically non-transitory machine readable instructions stored in the memory cells and utilized to direct the processor 107 to perform processes including (but not limited to) the various processes described below.

In many embodiments, the image processing pipeline application 110 controls the illumination of the scene via the illumination system 106 using the projector controller application 114. The image processing pipeline application 110 can control the capture of image data using an array 102 of cameras 104 to enable capture of an image and/or the natural texture of a scene. In several embodiments, the image processing pipeline application 110 can configure the processor 107 to process images captured by camera arrays 102 to produce a synthesized higher resolution image. Processes for performing super-resolution processing using image data captured by an array camera are described in U.S. Pat. No. 8,878,950 entitled “Systems and Methods for Synthesizing High Resolution Images Using Super-Resolution Processes” to Lelescu et al., the relevant disclosure from which including the disclosure related to performing super-resolution processes is hereby incorporated by reference in its entirety.

The image processing pipeline application 110 can also illuminate the scene using projected texture and estimate depths of objects within the scene using depth estimation processes similar to those described in U.S. Pat. No. 8,619,082 to Ciurea et al. and incorporated by reference above. The projected texture assists with depth estimation in textureless regions of the scene. In a number of embodiments, the image processing pipeline application 110 can use the projector controller application 114 to modify the modulation pattern of the projected texture to increase depth estimation precision at a specific distance from the camera array. In several embodiments, the image processing pipeline 110 collocates natural texture information and depth information to create a set of collocated depth and texture information. The collocation process assumes that the scene is static between the capture of a set of image data of the scene illuminated by projected texture and a set of image data captured when the scene is not illuminated by projected texture. In many embodiments, the collocation process utilizes a depth map generated from the set of images used to obtain the natural texture information. In a number of embodiments, the process of reprojecting the depth information into the field of view of the texture information (or vice versa) involves compositing depth information determined using projected texture and without projected texture. In certain embodiments, confidence maps are utilized to guide the compositing of depth information. Various processes for collocating depth and texture information in accordance with embodiments of the invention are discussed further below.

While specific camera arrays incorporating illumination systems are described above with reference to FIG. 1A-1I, any of a variety of camera arrays can be utilized in combination with a projection system to estimate depth based upon projected texture in accordance with embodiments of the invention. Before discussing various illumination systems that can be utilized in camera arrays to project texture in accordance with embodiments of the invention, the benefits that can be achieved when using two-dimensional arrays of cameras to perform depth estimation from projected texture generated by an illumination system in accordance with various embodiments of the invention are discussed further below.

### Utilizing Epipolar Lines Aligned at Different Angles to Perform Disparity Searches

Use of a two-dimensional array of cameras to estimate depth can involve determining the similarity of corresponding pixels in a plurality of images at different depths. Due to the spatial relationship of cameras in a two-dimensional array of cameras, the epipolar lines searched during the disparity search are aligned at different angels. In a binocular stereo system that utilizes a random projected texture, self-similar regions of projected texture can result in incorrect depth estimates. When disparity searches are conducted across epipolar lines aligned at different angles, the likelihood that a random projected texture includes similar patterns in corresponding pixel locations along multiple epipolar lines aligned at different angles is low. Indeed, the likelihood decreases with the increase in the number of cameras in the array utilized to perform the epipolar line search. Epipolar lines utilized to perform disparity searches in a 2×2 array of monochrome cameras are illustrated in FIG. 2A. The camera 202 in the top right hand corner of the array forms a reference camera and arrows indicate the direction of anticipated shifts of corresponding pixels with depth in alternate view images captured by the remaining three cameras 204. As can readily be appreciated, disparity searches involve searching along three different epipolar lines aligned at different angles with respect to each other.

Epipolar lines utilized to perform disparity searches in a 5×5 array of monochrome cameras including 17 Green cameras 4 Red cameras and 4 Blue cameras are illustrated in FIG. 2A. Assuming that the disparity search is performed using only the corresponding pixels from the Green cameras, disparity searches involve searching along eight different epipolar lines aligned at different angles with respect to each other. In other embodiments, the number of epipolar lines searched can be increased by utilizing corresponding pixels in each of the three color channels in the manner described in U.S. Pat. No. 8,780,113 entitled “Systems and Methods for Performing Depth Estimation using Image Data from Multiple Spectral Channels”, to Ciurea et al., the relevant disclosure from which is hereby incorporated by reference in its entirety. As can readily be appreciated, the specific number and type of cameras utilized to perform disparity searches is largely dependent upon the requirements of a specific application. By increasing the number of cameras in the array and/or the number of dimensions in the array (i.e. 1D to 2D), however, significant benefits can be achieved when estimating depth using projected textures irrespective of the size of the array. Where arrays of cameras are spaced with a wide baseline, the wide baseline can become the dominant epipolar direction. In several embodiments, projected patterns that are orthogonal to the dominant epipolar direction can increase the importance of other epipolar directions in the depth estimation process. Systems for projecting texture that can be utilized by camera arrays in accordance with embodiments of the invention are described further below.

### Illumination Systems Utilized to Project Texture

A variety of illumination systems can be utilized to project texture for use in depth estimation in accordance with embodiments of the invention. In several embodiments, static illumination systems are utilized that project a fixed pattern. In a number of embodiments, dynamic illumination systems are utilized in which the projected pattern is controllable. As discussed further below, camera arrays in accordance with many embodiments of the invention can control the projected pattern so that the spatial resolution of the intensity contrast is selected to provide the greatest depth estimation precision at the depths at which objects are observed in the scene. In certain embodiments, an illumination system incorporating an array of projectors is utilized. In several embodiments, the projector array projects a fixed pattern. In other embodiments, the pattern projected by the projector array is controllable so that the spatial resolution of the intensity contrast is selected to provide the greatest depth estimation precision at the depths at which objects are observed in the scene.

### Static Illumination Systems

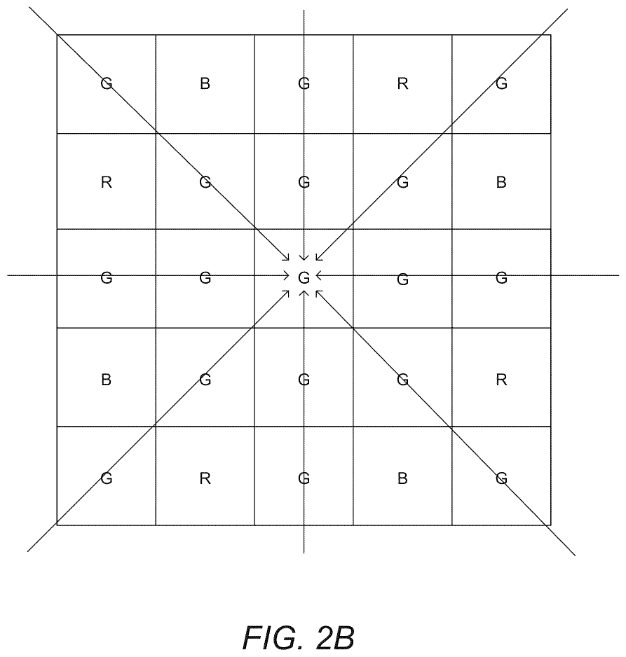

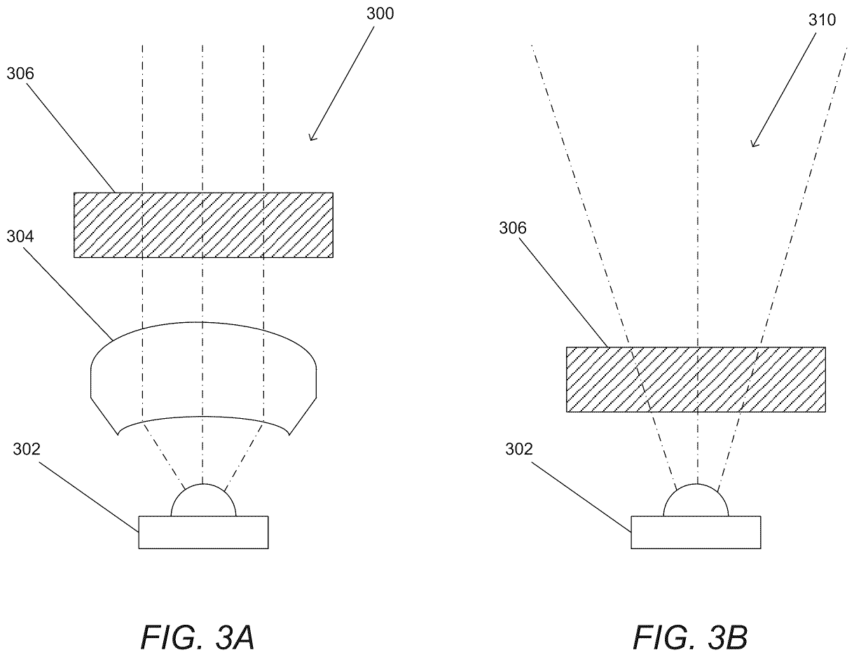

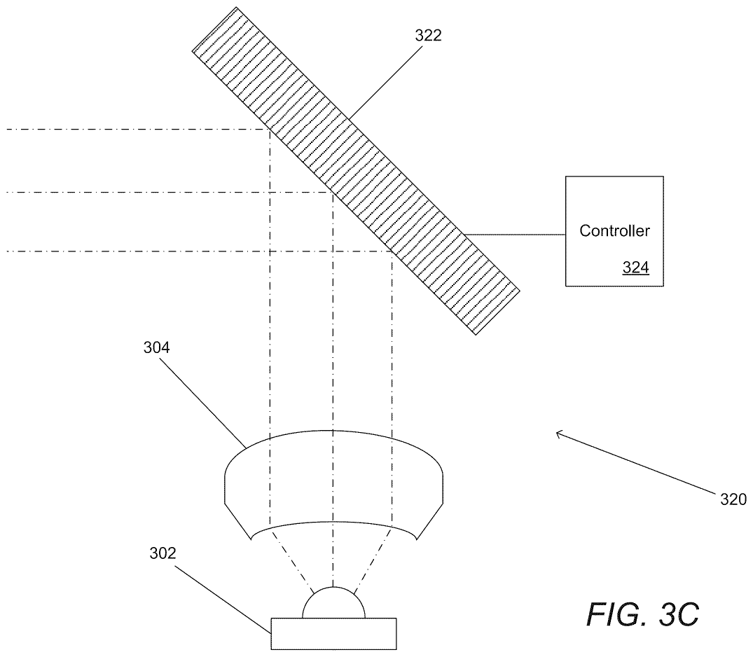

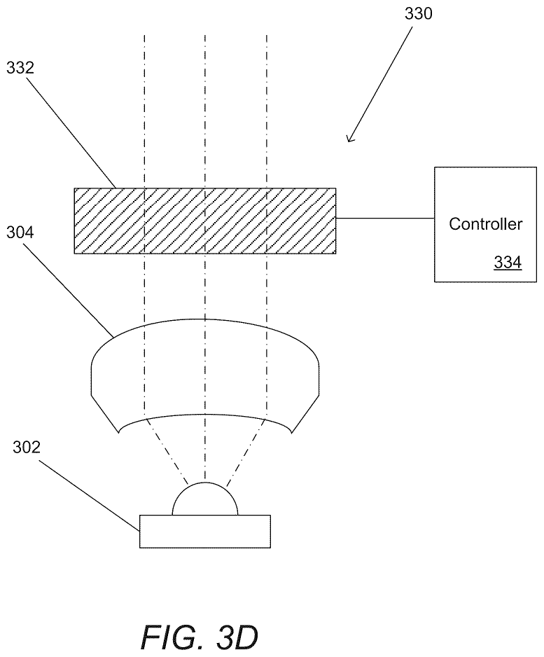

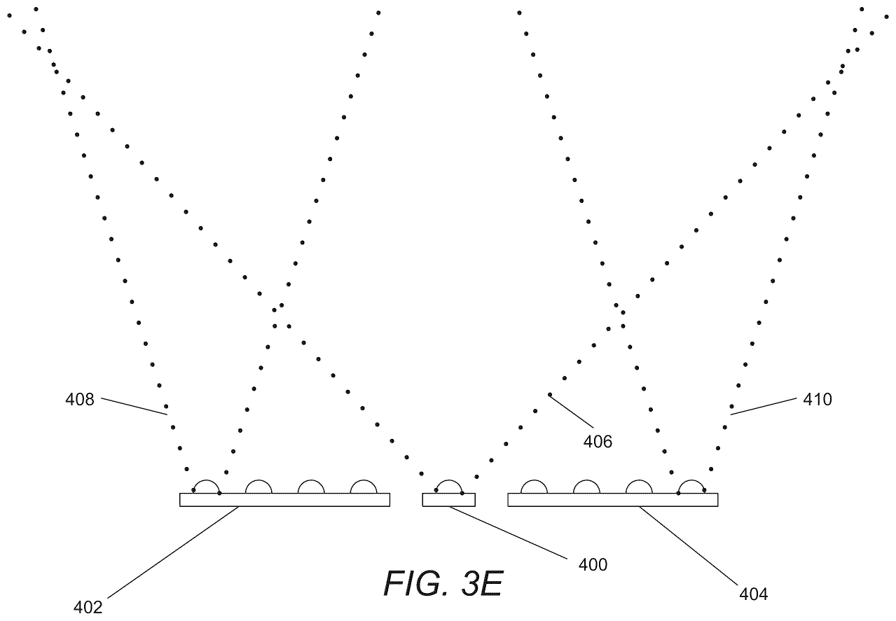

A diffractive static illumination system in accordance with an embodiment of the invention is illustrated in FIG. 3A. The static illumination system 300 includes a light source 302. In several embodiments, the light source 302 is a monochromatic point source such as (but not limited to) a single mode fiber end face (potentially cleaned up by a spatial frequency filter), a laser diode, or a vertical-cavity surface-emitting laser (VCSEL). The light source 302 emits light that is collimated by a collimator 304 such as (but not limited to) a collimating lens. The collimated light is incident on a diffractive optical element (DOE) 306. If the DOE is designed appropriately to include a spherical phase component, the collimator 304 can be omitted from the static illumination system 300. A static illumination system 310 in which light from the light source 302 is directly incident on the DOE 306 is shown in FIG. 3B. In a number of embodiments, the DOE 306 is a phase grating such as binary or multilevel gratings. In other embodiments, amplitude gratings can also be utilized. In many embodiments, the features of the texture can be color or polarization and is not simply limited to spot shape and separation.

When using a conventional diffractive static illumination system, the angular period of the projected pattern is fixed or constant. In several embodiments, the projected texture can employ random texture, texture generated using De Bruijn sequences or texture generated based upon Hamming codes. As can readily be appreciated, any texture appropriate to the requirements of a specific application can be statically projected in accordance with embodiments of the invention by designing the potentially more complex DOE (theoretically any intensity distribution can be generated with the appropriately designed DOE from a coherent source). Random patterns are most desirable for the array camera in order to avoid confusion of the parallax detection process due to false parallax matches that can arise from a periodic texture pattern. Although, in many embodiments any of a variety of non-periodic texture and/or periodic texture patterns can be utilized as appropriate to the requirements of specific applications. Irrespective of the projected texture, texture projected by a static illumination system has a spatial pattern period that increases with distance. In several embodiments, the spatial period can be modified utilizing a controllable DOE to provide a spatial pattern period that is likely to yield the highest depth estimation precision at a given depth. In many embodiments, the system is designed so that suitable depth estimation precision is obtained at a minimum object distance. At the minimum object distance the pattern is determined so that adjacent points projected on the object at the minimum distance after being modulated by the camera array's blur (both lens and sensor) is still discernable as distinct points. Therefore, the modulation transfer function of the imaging systems needs to be taken into consideration in designing the density of projected patter at the minimum desired operating distance.

In several embodiments, an illumination system can be constructed using a light emitting diode as a light source. However, the LED needs to be structured and then imaged by a projection lens (“relayed”) into the scene in order to provide projected texture. Alternatively, the LED can be homogenized (e.g. with a microlens array condenser) and illuminated a diaphragm that has the desired (de-magnified, ideally non-periodic) projection pattern in it, which is then also imaged into the scene. An appropriately configured LED can be utilized as a single device or as part of an array. In several embodiments, the typically lithographically manufactured diaphragm or array of diaphragms can be replaced by a translucent LCD in order to provide the flexibility to change the projection pattern. Various dynamic illumination systems in accordance with embodiments of the invention are described below.

### Dynamic Illumination Systems

A variety of dynamic illumination systems can be constructed using devices such as (but not limited to) spatial light modulation systems. Spatial light modulation systems are devices that can be used to modulate in a controllable manner the amplitude, phase, and/or polarization of light waves in space and time. In a number of embodiments, the spatial light modulator system is implemented using a reflective liquid crystal on silicon microdisplay. In many instances a spatial light modulation system is pixelated, which means that different phase, transmission, and/or polarization parameters can be applied to different spatial locations within the spatial light modulation system. In this way, the spatial light modulation system acts as a programmable grating (within the limits of its pixilation) in the case of its use in a diffractive pattern generator and a programmable diaphragm in the case of a reflective projector. An illumination system 320 including a reflective spatial light modulator system 322 is illustrated in FIG. 3C. A controller 324 controls the modulation applied to the incident light generated by the light source 302. In the illustrated embodiment, the incident light is shown as calumniated by the collimator 304. As noted above, a collimator can be omitted where the modulation pattern is selected appropriately. The controller 324 can be implemented via a dedicated device and/or using a processor forming part of the camera array that incorporates the dynamic illumination system.

In several embodiments, the spatial light modulator system is implemented using a translucent liquid crystal microdisplay. An illumination system 330 including a translucent spatial light modulator system 332 is illustrated in FIG. 3D. A controller 334 controls the modulation applied to the incident light generated by the light source 302. In the illustrated embodiment, the incident light is shown as calumniated by the collimator 304. As noted above, a collimator can be omitted where the modulation pattern is selected appropriately. The controller 334 can be implemented via a dedicated device and/or using a processor forming part of the camera array that incorporates the dynamic illumination system.

The ability to control the modulation pattern enables the selection of a modulation pattern(s) that are specific to the depths of objects within a scene. In several embodiments, initial depth estimates are determined with respect to objects in a scene and the initial depth estimates utilized to generate a projected texture having spatial pattern periods determined based upon the depths of the objects illuminated by specific portions of the projected texture. Similar techniques can be utilized to generate a set of textures that provide different levels of depth estimation precision at various depths. These textures can then be projected in a sequence and the depth estimates obtained using the projected texture likely to yield the highest depth estimation precision utilized to determine distances to objects visible within the scene. In this way, each set of captured images is only utilized to perform depth estimation within a given range of disparities at which a given projected texture yields the highest depth estimation precision.

In several embodiments, the projected texture can employ random texture, texture generated using De Bruijn sequences or texture generated based upon Hamming codes. As noted above, the spatial pattern periods of different regions of the texture can be modified based upon the depths of the objects illuminated by the projected texture. Alternatively, textures that provide different levels of depth estimation precision at various depths can be projected in a sequence and the depth estimates obtained using the projected texture likely to yield the highest depth estimation precision utilized to determine distances to objects visible within the scene.

Irrespective of whether the illumination system is static or dynamic, the illumination system will ideally be designed to project texture across the entire field of view of each of the cameras in the camera array. When cameras are located in complementary occlusion zones on either side of an illumination system, the field of view onto which the illumination system projects texture is typically significantly larger than the fields of view of the cameras. The comparative field of view onto which an illumination system projects light and the fields of view of cameras in a camera array is conceptually illustrated in FIG. 3E. An illumination system 400 is surrounded by two arrays of cameras 402, 404 located in complementary occlusion zones. The field of view 406 onto which the illumination system 400 projects light is significantly wider than the fields of view 408, 410 of the cameras in the arrays of cameras 402, 404. Beyond a predetermined distance, the projected texture is visible throughout the entire field of view 408, 410 of the cameras in the arrays of cameras 402, 404 (assuming an absence of foreground objects).

While a variety of illumination systems are described above with reference to FIGS. 3A-3D that use a single light source, illumination systems in accordance with several embodiments of the invention utilize multiple projectors. Illumination systems incorporating arrays of projectors in accordance with various embodiments of the invention are discussed below.

### Projecting Textures Using Arrays of Projectors

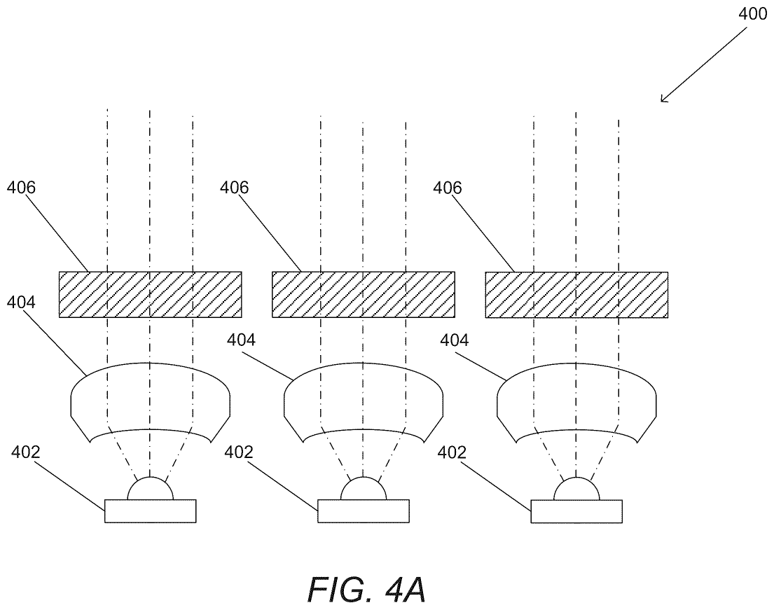

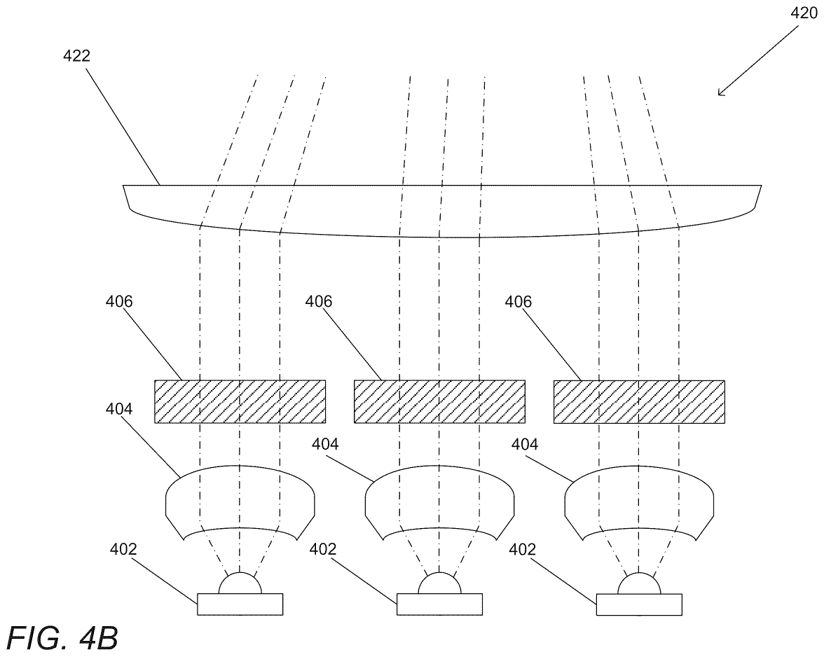

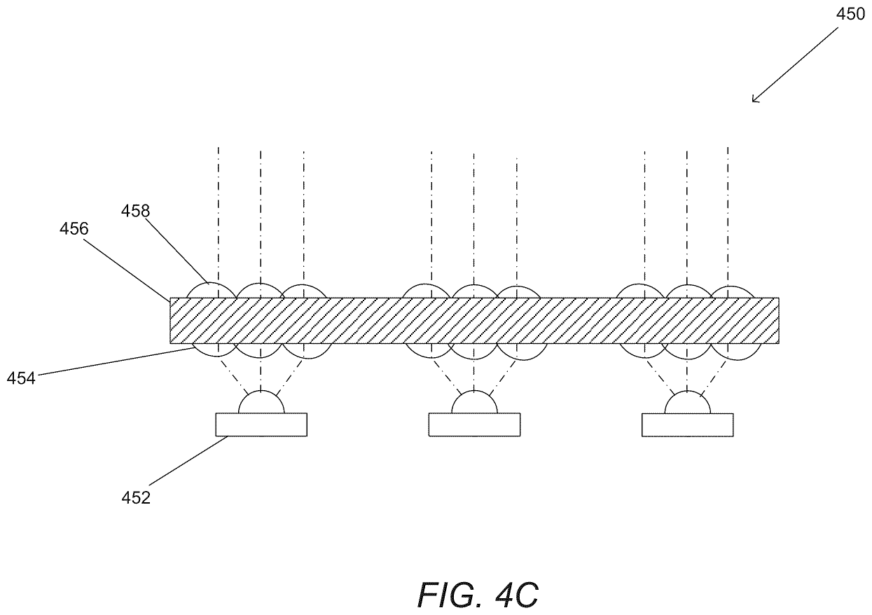

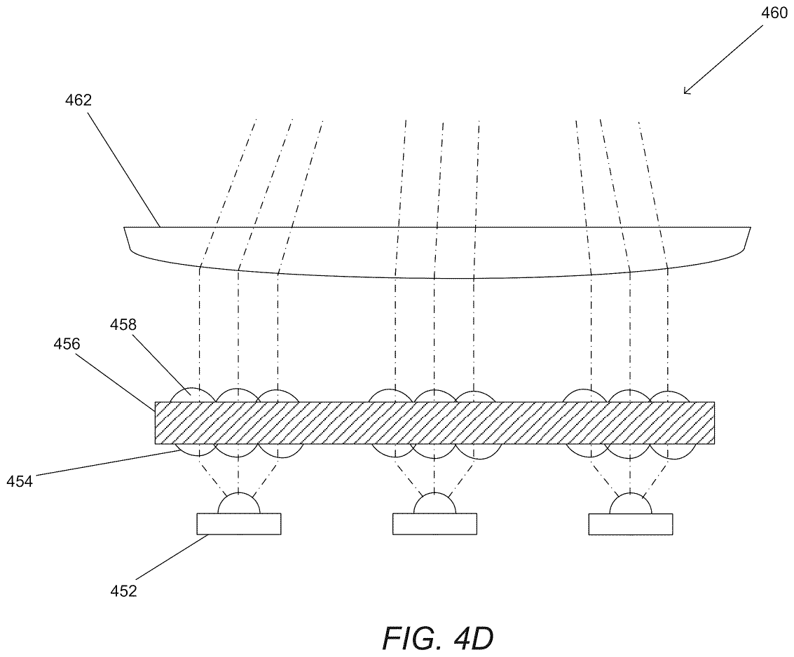

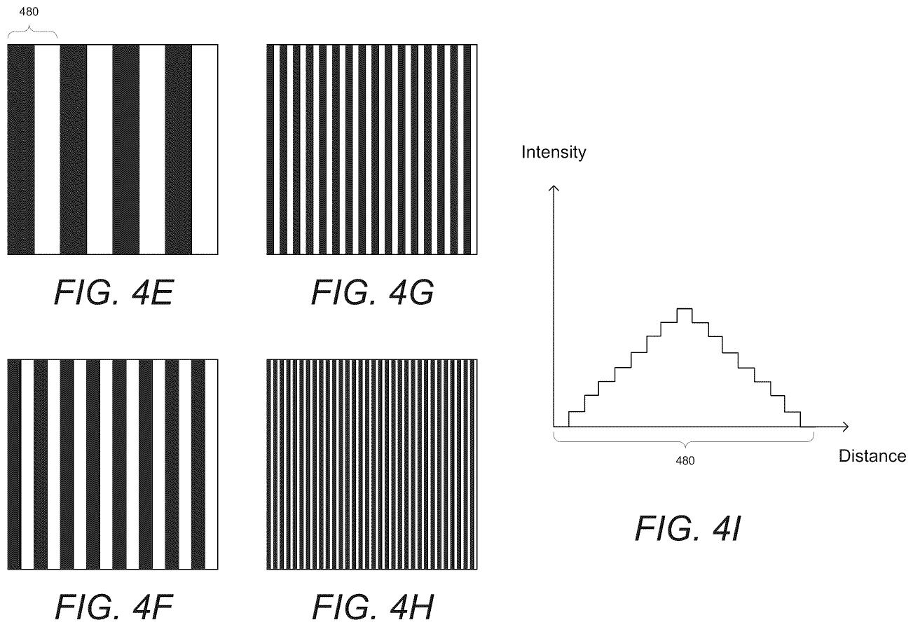

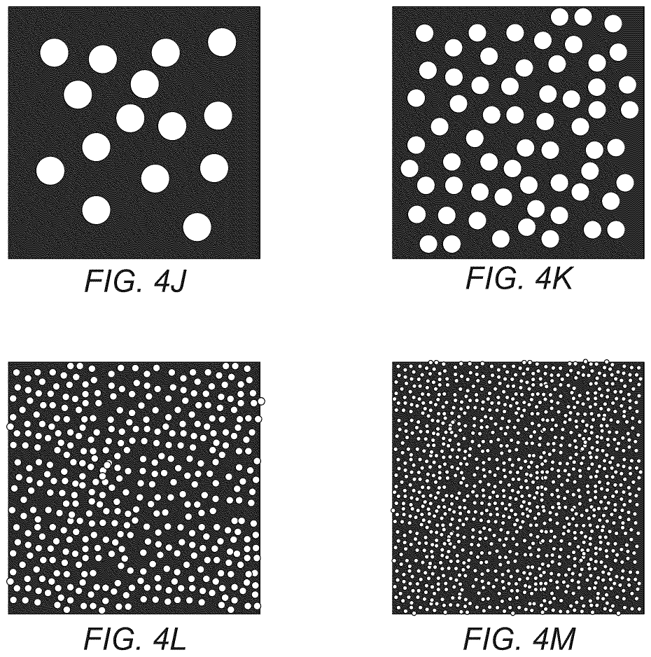

An array of projectors that project collimated light through DOEs in accordance with an embodiment of the invention is illustrated in FIG. 4A. The projectors in the projector array 400 each include a light source 402 and a collimator 404. In the illustrated embodiment, the collimator 404 is a collimating lens. In other embodiments, any of a variety of collimators can be utilized and/or the collimated can be omitted. The collimated light from each light source 402 passes through a DOE 406 that modulates the light projected onto the scene. In several embodiments, a lens can be utilized to focus the projected light. An array of projectors 420 that project collimated light through DOEs through a lens 422 that focuses the light on a focal plane in accordance with an embodiment of the invention is illustrated in FIG. 4B. As can readily be appreciated the modulation patterns utilized in the array of projects can be static or dynamic as appropriate to the requirements of specific applications. Furthermore, different projectors in the array of projectors having different DOEs and/or colored light sources could be switched on in different combinations to create different patterns.

In a number of embodiments, a projector array is constructed using a plurality of light emitting diodes (LED)s. A projector array formed by a plurality of LEDS is illustrated in FIG. 4C. The projector array 450 includes LEDs 452 that project light onto a set of condenser microlenses 454 in a microlens array that can be formed upon a glass substrate 456. Modulation patterns can be patterned onto the glass substrate that modulate light passing through the substrate and project light via projection microlenses 458 in a microlens array formed upon the opposite surface of the glass substrate. Each combination of a condenser and projector microlens can be considered to be a micro-projection unit. In several embodiments, a lens can be utilized to focus the projected light onto a focal plane. An array of projectors 460 that focuses light emerging from the projector microlenses on a focal plane using a lens 462 in accordance with an embodiment of the invention is illustrated in FIG. 4D.

Projector arrays can be utilized to project a variety of patterns in accordance with various embodiments of the invention. A projected texture that includes intensity modulation can be achieved using Gray code patterns in which different projectors project overlaying patterns of increasingly smaller spatial pattern periods. Gray code patterns are conceptually illustrated in FIGS. 4E-4H. The increase in intensity across one spatial pattern period 480 of the pattern having the largest spatial pattern period shown in FIG. 4E is illustrated in FIG. 4I. As can readily be appreciated, the effect of projecting the Gray code patterns is to successively increase and decrease the intensity of the projected pattern across scene onto which the texture is projected. In several embodiments, Gray code patterns are used in combination with phase-shifted shaped fringe projection patterns.

The patterns described above with reference to FIGS. 4E-4H vary in a predictable pattern across the scene. When two-dimensional camera arrays are utilized to estimate depth, the projected texture will ideally vary along every epipolar line searched during the depth estimation process. As noted above, the spatial pattern period may be different along different epipolar lines for reasons including (but not limited to) compensating for the presence of a dominant epipolar line. Accordingly, projector arrays in accordance with many embodiments of the invention project random textures. The use of a series of projected patterns incorporating randomly located dots having different sizes is illustrated in FIGS. 4J-4M. As can readily be appreciated, the projection of the different random dot patterns can achieve a random pattern having non-deterministic intensity variations (color variations and/or phase variations) with a spatial pattern period determined based upon the size of the smallest dots. Due to the randomness of the projected patterns, there are likely to be some regions within the pattern that are similar. The likelihood that these regions will be located in regions along multiple epipolar lines that correspond at a specific depth is low. Therefore, the random pattern can provide improved performance in the context of camera arrays that estimate depth using two-dimensional arrays of cameras. Where the generation of patterns by the projector array is controllable, the spatial pattern period can be controlled so that the spatial pattern period provides increased depth estimation precision at a given depth. In several embodiments, spatial pattern period is controlled by only illuminating the scene using projectors having static spatial patterns with spatial pattern periods above a specified threshold. In this way, additional projectors can be used to successively illuminate the scene and depth estimates obtained using the image data captured when the scene was illuminated with projected texture that yields the highest depth estimation precision at a given depth. Where a large projector array is utilized, different projectors can be utilized to illuminate different portions of the field of view of the cameras in the camera array and the spatial pattern periods in each region modified in the manner outlined above based upon an initial depth estimate for the region.

Although specific projector arrays and sets of patterns that can be utilized by projector arrays are described above with reference to FIGS. 4A-4M, any of a variety of projector arrays and/or projected patterns can be utilized to project texture for the purposes of estimating depth using a camera array as appropriate to the requirements of specific applications in accordance with embodiments of the invention. Camera arrays incorporating arrays of projectors in accordance with various embodiments of the invention are discussed further below.

### Camera Arrays Incorporating Arrays of Projectors

An illumination system incorporating an array of projectors can be utilized in any camera array configuration incorporating an illumination system. FIGS. 5A-5I illustrate camera array systems 500, 520, 530, 540, 550, 560, 570, 580, 590 corresponding to the camera array systems 100, 120, 130, 140, 150, 160, 170, 180, 190 illustrated in FIGS. 1A-1I with the exception that the illumination systems 106 include an array of projectors 502. As can readily be appreciated, camera arrays including arrays of cameras, and/or arrays of projectors located in any of a variety of configurations can be utilized as appropriate to the requirements of specific applications in accordance with embodiments of the invention.

### Capturing Depth and Natural Texture of an Imaged Scene

Many applications require capture of the texture of a natural scene in addition to determining depth information. Camera arrays in accordance with a number of embodiments of the invention are configured to capture image data of a scene without illumination with projected texture and image data of the same scene illuminated with projected texture. The image data concerning the natural texture of the scene can be combined with depth estimates obtained using the projected texture. In several embodiments, the natural texture of the scene is rendered as an image and the depth map is registered with respect to the image. In a number of embodiments, the combined data is used to form a point cloud and/or to generate a mesh and texture for one or more objects visible within the scene. Where motion between the capture of the two sets of image date is negligible, then collation is a simple matter as the data can be assumed to be captured from the same viewpoint. Where significant motion is allowed, depth maps generated using each set of data and/or other depth queues can be utilized to detected corresponding features and determine the motion of the camera array between the capture of the sets of data.

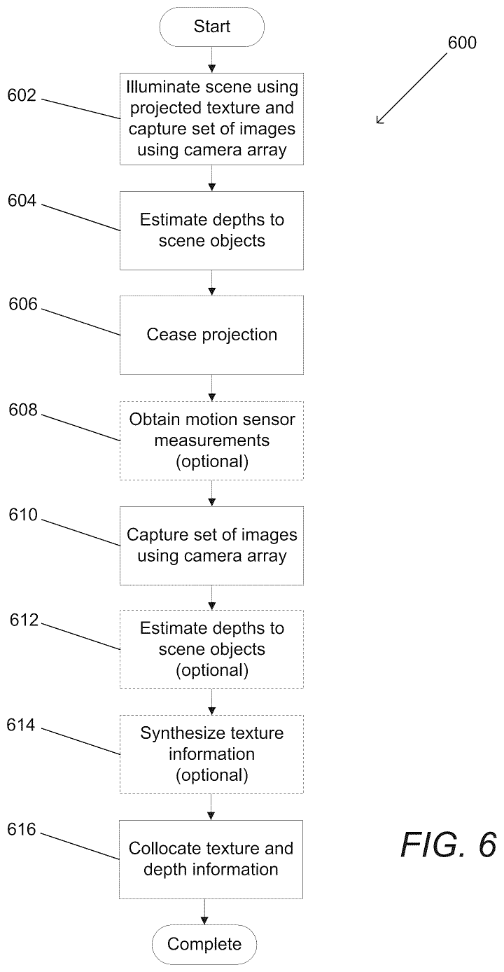

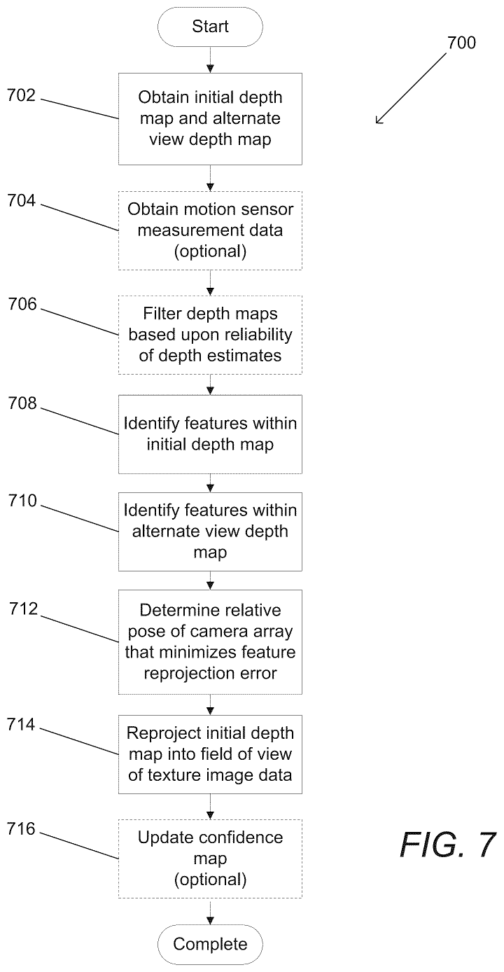

A process for collocating natural texture and depth information in accordance with an embodiment of the invention is illustrated in FIG. 6. The process 600 includes illuminating (602) a scene using projected texture and capturing a set of images using a camera array. As noted above, the projected texture can be static, a sequence of dynamic textures or determined dynamically based upon initial depth estimates. A set of images captured by cameras in the camera array can be utilized to estimate (604) depths of objects visible within the scene. In a number of embodiments, the depth estimates are utilized to generate a depth map. In several embodiments, a confidence map is generated to indicate the reliability of depth estimates within the depth map. Any of a variety of confidence metrics can be utilized including (but not limited to) those described above in U.S. Patent U.S. Pat. No. 8,619,082 to Ciurea et al., the relevant disclosure from which related to confidence metrics is hereby incorporated by reference herein in its entirety.

The illumination system ceases (606) projection. Where motion is allowed and the camera array incorporates motion sensors, motion measurements can optionally be obtained (608). The motion measurements can be utilized in subsequent processing related to estimating the relative poses of the cameras in the camera array between capture of sets of image data.

A set of image data is captured (610) in which the natural texture of the scene is visible using cameras in the camera array. In a number of embodiments, depths to scene objects are optionally estimated (612). The depth information can be utilized to identify features or sets of features that are similar to features or sets of features visible in the depth information obtained from the set of images in which the projected texture is visible.

Where the cameras in the array capture image data in different spectral channels, texture information may be optionally synthesized (614) using image data from the various spectral channels. In many embodiments, the synthesis involves performing fusion of the image data. In several embodiments, the synthesis involves performing a super-resolution similar to the super-resolution processes referenced above. In other embodiments, the natural texture of the scene is captured using a single monochrome camera or a single Bayer camera in the camera array.

When information concerning the natural texture of the scene and information concerning the depths of objects within the scene is obtained, the information can be collocated to create a set of information that includes both texture and depth. A variety of processes can be utilized to collocate the two sets of information. In several embodiments, depth information determined using the natural texture of the scene can be utilized to reproject one of the sets of information into the viewpoint of another of the sets of information. In other embodiments, any of a variety of depth cues discernible from the texture information can be used to perform colocation. In certain embodiments, texture that is likely to yield reliable depth estimates and the confidence map are utilized to perform colocation. As can readily be appreciated, the sequence in which the sets of image data are captured in FIG. 6 can be reversed.

### Reprojecting Depth Maps

A process for reprojecting depth information into the viewpoint of a set of texture information in accordance with an embodiment of the invention is illustrated in FIG. 7. The process 700 includes obtaining (702) an initial depth map and an alternate view depth map. The initial depth map can be generated using a set of image data captured when the scene is illuminated with projected texture. The alternate view depth map can be generated using image data captured of the scene when the illumination system does not illuminate the scene and so the natural texture of the scene is visible. Where motion sensor measurement data is available, motion sensor measurement data can also be obtained (704) to assist with determining the relative pose of the cameras in the array between the viewpoint of the initial depth map and the viewpoint of the alternate view depth map.

In many embodiments, the depth maps are filtered (706) based upon confidence maps to eliminate depth estimates that are unreliable. Features can then be identified (708, 710) in each depth map. Any of a variety of features can be utilized to identify a landmark including (but not limited to) features identified using Scale-invariant Feature Transform (SIFT) descriptors, features identified using Speeded Up Robust Features (SURF) descriptors, and/or features identified using Binary Robust Independent Elementary Features (BRIEF) descriptors. As can readily be appreciated, the specific technique utilized to identify features is largely dependent upon the requirements of a specific application.

The relative pose of the cameras in the array between the viewpoint of the initial depth map and the viewpoint of the alternate view depth map can be determined (712) by minimizing the reprojection error of a set of common features visible in both the initial depth map and the alternate view depth map. Any of a wide variety of structure from motion techniques can be utilized to determine the relative pose that minimizes reprojection error. In several embodiments, the search process is assisted by the availability of motion sensor measurement data.

The relative pose can be utilized to reproject (714) the initial depth map into the field of view of the texture information and obtain collocated depth and texture information. In many embodiments, the reprojection can provide additional information concerning the reliability of the reprojected depth estimates. In several embodiments, the confidence map of the reprojected depth information is optionally updated (716). In certain embodiments, the confidence maps of the reprojected initial depth map and the alternate view depth map can be utilized to composite depth estimates from the two depth maps. In this way, depth estimates at the edges of objects that are generally very reliable in natural scenes can be utilized in the composited depth map. In many embodiments, edge maps are utilized to guide the compositing and the depth estimates are filtered to provide realistic depth transitions between depth information composited from the two depth maps. As can readily be appreciated, any of a variety of techniques can be utilized to composite depth maps as appropriate to the requirements of specific applications in accordance with embodiments of the invention.

While specific processes for collocating depths information and texture information obtained using a camera array incorporating an illumination system are described above with reference to FIGS. 6 and 7, any of a variety of processes can be utilized to collocate depth and texture information as appropriate to the requirements of specific applications. Furthermore, such processes can be utilized with any of a variety of camera architectures including binocular stereo camera arrays incorporating a single static illumination system in accordance with many embodiments of the invention.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

What is claimed is:

1. A camera array, comprising:
a conventional camera;
at least one two-dimensional array of cameras comprising a plurality of cameras, wherein the conventional camera has a higher resolution than the plurality of cameras in the at least one two-dimensional array of cameras, wherein a horizontal baseline between the conventional camera and the at least one two-dimensional array of cameras is larger than a vertical baseline between cameras within the at least one two-dimensional array of cameras;
an illumination system configured to illuminate a scene with a projected texture;
a processor; and
memory containing an image processing pipeline application and an illumination system controller application;
wherein the illumination system controller application directs the processor to control the illumination system to illuminate a scene with a projected texture;
wherein the image processing pipeline application directs the processor to:
utilize the illumination system controller application to control the illumination system to illuminate the scene with the projected texture;
capture using the conventional camera and the at least one two-dimensional array of cameras, a set of images of the scene illuminated with the projected texture;
determine depth estimates for pixel locations in an image from a reference viewpoint using at least a subset of the set of images, wherein generating a depth estimate for a given pixel location in the image from the reference viewpoint comprises:
identifying pixels in the at least a subset of the set of images that correspond to the given pixel location in the image from the reference viewpoint based upon expected disparity at a plurality of depths along a plurality of epipolar lines aligned at different angles;
comparing the similarity of the corresponding pixels identified at each of the plurality of depths; and
selecting the depth from the plurality of depths at which the identified corresponding pixels have the highest degree of similarity as a depth estimate for the given pixel location in the image from the reference viewpoint;
process the set of images using the depth estimates to produce a synthesized higher resolution image.
